(19) United States
(12) Patent Application Publication
(10) Pub. No.: US 2025/0194651 A1
(43) Pub. Date: Jun. 19, 2025

(54) STEVIOL GLYCOSIDE CONCENTRATES AND HIGHLY SOLUBLE STEVIOL GLYCOSIDES

(71) Applicant: CARGILL, INCORPORATED, Wayzata, MN (US)

(72) Inventor: Daniel Scott Gaspard, Victoria, MN (US)

(73) Assignee: CARGILL, INCORPORATED, Wayzata, MN (US)

(21) Appl. No.: 18/844,299

(22) PCT Filed: Feb. 27, 2023
(86) PCT No.: PCT/US2023/063340

§ 371 Date: Sep. 5, 2024

Related U.S. Application Data
(60) Provisional application No. 63/269,476, filed on Mar. 17, 2022.

(51) Int. Cl. A23L 27/30; A23L 2/60

(52) U.S. Cl. CPC A23L 27/36; A23L 2/60

(57) ABSTRACT

A method for making highly soluble steviol glycoside compositions. The method can provide steviol glycoside solutions having a high concentration of dissolved steviol glycosides, and which exhibit long-term resistance to precipitation. Various steviol glycoside compositions containing solubilized rebaudioside M and rebaudioside A are described, including both liquid and dry compositions.

### CROSS-REFERENCE TO RELATED APPLICATIONS

This application claims the benefit of U.S. Provisional Application No. 63/269,476, filed Mar. 17, 2022, which is incorporated by reference herein in its entirety.

### BACKGROUND

Steviol glycosides are naturally occurring glycosylated diterpene compounds that can be used as reduced-calorie sweeteners. Various such compounds are known, each having differing properties, taste profiles, and chemical structures. A typical steviol glycoside is characterized by a single steviol backbone and contains one or more carbohydrate residues at C13 and C19. For example, rebaudioside A contains a branched group of three glucosyl groups at C13 and a single β-glucosyl at C19, while rebaudioside D contains the same unit at C13 but a diglucosyl at C19. Steviol glycosides can serve as powerful sweeteners even at low concentrations-providing a sweetening effect approximately 150 to 450 times greater than an equivalent amount of sugar.

However, unlike sugar, steviol glycosides do not easily dissolve, or stay dissolved, in aqueous solution. Both manufacturers and consumers desire using steviol glycosides in water-based compositions such as beverages and food. The problem of poor steviol glycoside solubility is readily observable, but it is not readily explained. For example, in water at 25° C., purified rebaudioside A can dissolve to achieve a dissolved content of about 0.8 wt % in aqueous solution at room temperature. (WO 2012/082587 A2) Yet other steviol glycosides-which have relatively similar structures—have very different solubility properties. In aqueous solution at 25° C., conventional formulations of rebaudioside M can dissolve to about 0.1 wt % while formulations of rebaudioside D can dissolve to about 0.05 wt % (WO 2017/120480 A1). The consequences are two-fold: poor initial dissolution causes problems for manufacture of sweetener compositions and sweetened products, while the instability of solutions results in poor shelf-life due to precipitation that degrades appearance, taste, texture, and processability

One set of approaches to improve solubility of steviol glycosides has involved using freeze drying or spray drying but doing so provides only a slightly more soluble composition (WO 2017/120480 A1). For example, WO '480 describes a dissolving 0.5 wt % rebaudioside M in an aqueous solution at room temperature but does not report whether the solution remained stable over time and attempts to obtain greater concentrations resulted in mixtures having observable murkiness. WO 480 describes a 1% and 2% spray-dried mixture of rebaudioside M which is unstable and involves either precipitate or other non-solution phase steviol glycosides as evidenced by a turbidity of between 9 and 21 (Formazin Attenuation Units). Other attempts to improve solubility of steviol glycosides involves use of elevated temperatures, evaporative crystallization, or hot spray drying (WO 2019/241332 A1). However, these techniques risk thermal degradation of steviol glycosides and involve the additional disadvantage of requiring high processing temperatures, resulting in additional costs during manufacture.

Other approaches involve use of solubility enhancer additives or solvents. Alcohols (e.g., ethanol) and solvents other than water can be used to dissolve steviol glycosides, but manufacturers and consumers desire sweetener compositions that are water-based and also alcohol-free.

The poor solubility of steviol glycosides is problematic in the context of sweetened beverages where the feasible amount of solubilized steviol glycosides may be below the desired level of sweetness. The upper bound limitations on steviol glycoside solubility are especially problematic in the context of commercial-scale food operations, which desire using throw syrups (e.g., that are diluted by a factor of 5:1 in water prior to consumption) to provide the desired beverage sweetness and flavor, yet such throw syrups can require higher concentrations of dissolved sweetener than is conventionally feasible. Presenting an even greater challenge, food manufacturers desire stable and reliable steviol glycoside concentrates having an even higher concentration of dissolved steviol glycosides than is found in syrups and beverages.

### SUMMARY

The present disclosure provides, among other things, a method for making stable, highly concentrated steviol glycoside compositions, which are useful for beverage and food manufacturing, restaurants, and shipping. In various aspects, the method can provide compositions having a remarkably high concentration of dissolved steviol glycoside content-without the need for solubility enhancing additives, solvents, spray drying, or thermally-demanding techniques. In various aspects, a stable, clear solution, free of visible precipitates, can be obtained containing 5 wt % or more of dissolved steviol glycosides (based on total weight of the solution), and which exhibits long-term stability against precipitation.

In the context of food preparation, highly concentrated steviol glycosides are useful as ingredients for throw syrups or as direct ingredients to beverages and foods. Prior to the present disclosure, the low solubility of conventional steviol glycosides would be problematic in such environments due to the tendency of dissolved steviol glycosides to precipitate or ‘crash out’ of solution over time, which results in equipment fouling, clogging of transfer lines, and ruined beverage and food due to lower than expected sweetness. Food and beverage manufacturers desire steviol glycosides that dissolve to a high concentration—and stay dissolved. Various aspects of the present disclosure provide a highly concentrated, yet stable, aqueous solution of steviol glycosides, which have the advantage that they do not suffer from precipitation-induced equipment fouling, maintain a clear appearance, and do not degrade to a heterogeneous state.

Various aspects of the disclosure provide a method for making a concentrated steviol glycoside composition, which involves combining a mixture of steviol glycosides containing rebaudioside M and rebaudioside A at a weight ratio of 0.2 to 0.9 (i.e., 0.2:1 RebM:RebA to 0.9:1 RebM:RebA) in an aqueous solvent, heating the solution to at least 70° C. for at least 2.5 minutes, at least 75° C. for at least 1.5 minutes, or at least 80° C. for at least 1 minute, dissolving the rebaudioside M and rebaudioside A to a concentration of at least 3 wt % and to a total steviol glycoside concentration of at least 5 wt %, and then permitting the resulting solution to cool.

The disclosure also provides a steviol glycoside concentrate in the form of an aqueous solution containing dissolved rebaudioside M and rebaudioside A at a combined concentration of at least 3 wt % and having a relative weight ratio of 0.2 to 0.9 and having a total content of dissolved steviol glycosides of at least 5 wt % of the entire aqueous solution. The composition can be stored at a temperature between 1° C. to 35° C. for at least 7 days without precipitating.

Various further aspects of the disclosure provide a method for making a highly soluble steviol glycoside composition, which involves combining a mixture of steviol glycosides containing rebaudioside M and rebaudioside A at a weight ratio of 0.2 to 0.9 in an aqueous solvent, heating the solution to dissolve the steviol glycosides to a concentration of at least 3 wt % and a total steviol glycoside concentration of at least 5 wt %, then drying the resulting solution by lyophilization or spray drying. The present disclosure further provides a highly soluble steviol glycoside composition, comprising the aforementioned dried mixture.

Advantages, some of which are unexpected, are achieved by aspects of the present disclosure. The inventor of the present disclosure unexpectedly discovered that certain ratios and amounts of rebaudioside M and rebaudioside A result in a highly soluble material, which is surprising given that each component alone imparts very poor solubility. Various aspects of the disclosure advantageously provide a composition having a higher concentration of one or more steviol glycoside (e.g., a higher concentration of rebaudioside A and M, and optionally N, J, O, DG, and/or D) dissolved in aqueous composition than would otherwise be achievable if dissolving the steviol glycoside in the aqueous solution alone. For example, 3 wt % or more, 4% or more, or 5% or more, of the total composition can be dissolved rebaudioside M and rebaudioside A, taken together; and 5 wt % or more, 7.5 wt % or more, or 10 wt % or more of the total composition can be total dissolved steviol glycosides. Another advantage is that such high concentration compositions can be achieved even without the use of additives such as non-aqueous solvents, alcohols (e.g., C1-C4 alcohols), surfactants, or solubility enhancers, and thus the resulting composition thus benefits by requiring fewer ingredients on the label. Moreover, these compositions can be obtained without use of spray drying, evaporative crystallization, or other thermally demanding techniques which can degrade steviol glycosides.

The present disclosure also advantageously provides a composition having a high concentration of dissolved steviol glycosides that are stable in solution for at least 7 days, at least 10 days, or at least 14 days or more without suffering from visible evidence of precipitation, such as settled particles, cloudiness, or increased opacity of the aqueous composition. Such compositions provide a reliable and predictable concentration of dissolved steviol glycosides over long periods. Reduced precipitation is an important advantage in food manufacturing, where precipitation can foul and clog equipment, and loss of dissolved sweetener is detrimental to the taste of the sweetened food compositions. Steviol glycoside compositions described herein can also have the benefit of being able to survive freezing temperatures without precipitating.

Surprisingly, various concentrated aqueous compositions of the present disclosure can be dried (e.g., via lyophilization), and yet subsequently provide the same advantageous properties when reconstituted with water. Without intending to limit to any mechanistic theory, it can be considered that certain ratios of rebaudioside M and rebaudioside A arrange to provide highly soluble clusters of steviol glycosides and result in a higher achievable dissolved concentration. It is remarkable and unintuitive that the desirable solubility properties of such mixtures would be maintained after initial solubilization-especially for periods of days, months, and longer—and even more surprising that such properties can be retained after removal of the solvent.

### DESCRIPTION OF THE DRAWINGS

The drawings illustrate generally, by way of example, but not by way of limitation, various aspects discussed herein.

FIG. 1 is a photograph showing two mixtures prepared by mixing steviol glycosides in water, heating to 85° C. for 20 minutes, then cooling to room temperature. The vial on the left is 1% DS Reb D in water and the vial on the right is 1% DS Reb D, Reb M, and Reb A (3% DS SG in total), showing that Reb D at 1% DS cannot achieve dissolution even after heating at 85° C., whereas the mixture of 1% DS Reb D, Reb M, and Reb A provides a clear solution free of any precipitate.

FIG. 2 provides a matrix showing the results of solution stability tests. Long term stability was tested by storage at room temperature and appearance was evaluated by visual observation. The white empty boxes indicate solutions that are stable over the long term, at least 2 weeks: the light gray, lined boxes indicate solutions that are stable over the short term, at least 72 hours, before precipitation occurred; and dark gray boxes indicate solutions which are unacceptable due to lack of dissolution or precipitation immediately or within 72 hours of preparation.

FIG. 3 shows photographs of solubility trials as outlined in Example 2 (top) and Example 3 (bottom).

FIG. 4 show photographs of three solubility trials in which co-dried steviol glycosides having a 2:3, 1:1, or 3:2 M: A ratio were reconstituted at various concentrations at room temperature.

FIG. 5 shows a chart tracking the total dissolved steviol glycoside content based on percent recovery of dissolved steviol glycosides (Y-axis) by week (Y-axis) for various compositions. This result shows that a M/A ratio of 0.1 (circles) is detrimental to the long-term stability of the solution.

FIG. 6 shows a chart tracking the total dissolved steviol glycoside content based on percent recovery of dissolved steviol glycosides (Y-axis) by day (X-axis) for differing M/A ratios of 1% DS steviol glycoside solutions. This result shows that a M/A ratio of 1.3 (left most bar in each group, solid black) is detrimental to the long-term stability of the solution.

FIG. 7 shows a chart tracking the total dissolved steviol glycoside content based on percent recovery of dissolved steviol glycosides (Y-axis) by day (X-axis) for differing M/A ratios of 5% DS steviol glycoside solutions. This result shows that a M/A ratio of 0.1 (right most bar in each group, having black and white diagonal lines) is detrimental to the long-term stability of the solution.

FIG. 8 shows a chart tracking the total dissolved steviol glycoside content based on percent recovery of dissolved steviol glycosides (Y-axis) by day (X-axis) for high concentration steviol glycoside solutions having a M/A ratio of 0.4. This result shows that a M/A ratio of 0.4 provides desirable results at even very high concentrations (e.g., up to 30 wt %).

FIG. 9 shows time until complete dissolution at various temperatures for a steviol glycoside solution with about 5% DS and a M/A ratio of about 0.93 as outlined in Example 10.

It should be understood that numerous other modifications and examples can be devised by those skilled in the art, which fall within the scope and spirit of the principles of the disclosure.

### DETAILED DESCRIPTION

Reference will now be made in detail to certain embodiments of the disclosed subject matter, examples of which are illustrated in part in the accompanying drawings. While the disclosed subject matter will be described in conjunction with the enumerated claims, it will be understood that the exemplified subject matter is not intended to limit the claims to the disclosed subject matter.

In this document, the terms “a,” “an,” or “the” are used to include one or more than one unless the context clearly dictates otherwise. The term “or” is used to refer to a nonexclusive “or” unless otherwise indicated. In addition, it is to be understood that the phraseology or terminology employed herein, and not otherwise defined, is for the purpose of description only and not of limitation. Any use of section headings is intended to aid reading of the document and is not to be interpreted as limiting: information that is relevant to a section heading may occur within or outside of that particular section. Furthermore, all publications, patents, and patent documents referred to in this document are incorporated by reference herein in their entirety, as though individually incorporated by reference. In the event of inconsistent usages between this document and those documents so incorporated by reference, the usage in the incorporated reference should be considered supplementary to that of this document: for irreconcilable inconsistencies, the usage in this document controls.

Values expressed in a range format should be interpreted in a flexible manner to include not only the numerical values explicitly recited as the limits of the range, but also to include all the individual numerical values or sub-ranges encompassed within that range as if each numerical value and sub-range were explicitly recited. For example, a range of “about 0.1% to about 5%” or “about 0.1% to 5%” should be interpreted to include not just about 0.1% to about 5%, but also the individual values (e.g., 1%, 2%, 3%, and 4%) and the sub-ranges (e.g., 0.1% to 0.5%, 1.1% to 2.2%, 3.3% to 4.4%) within the indicated range. The statement “about X to Y” has the same meaning as “about X to about Y,” unless indicated otherwise. Likewise, the statement “about X, Y, or about Z” has the same meaning as “about X, about Y. or about Z,” unless indicated otherwise.

In the methods described herein, the steps can be carried out in any order without departing from the principles of the invention, except when a temporal or operational sequence is explicitly recited. Furthermore, specified steps can be carried out concurrently unless explicit claim language recites that they be carried out separately. For example, a claimed step of doing X and a claimed step of doing Y can be conducted simultaneously within a single operation, and the resulting process will fall within the literal scope of the claimed process.

The term “about” as used herein can allow for a degree of variability in a value or range, for example, within 10%, within 5%, or within 1% of a stated value or of a stated limit of a range.

The term “substantially” as used herein refers to a majority of, or mostly, as in at least about 50%, 60%, 70%, 80%, 90%, 95%, 96%, 97%, 98%, 99%, 99.5%, 99.9%, 99.99%, or at least about 99.999% or more.

The term “weight percent,” “weight %,” “wt %” “% by weight.” is understood to mean the weight of an ingredient relative to the total weight of all other ingredients of the referenced composition, including solvent where applicable. For example, a composition that has 1 wt % of total steviol glycosides (e.g., a 1:1 mixture rebaudioside M and rebaudioside A) in purified water with no other ingredients, would have 1 gram of the steviol glycosides for every 99 grams of purified water (1 gram Reb M/(99 gram water+1 gram Reb M). Further, the above-described steviol glycoside component, even if dissolved, can be separately referred to as being 50 wt % rebaudioside A and 50 wt % rebaudioside M. It is generally intended that referring to a composition that is 10 wt % steviol glycoside has the same meaning as saying that 10 wt % of the composition is steviol glycoside. Further, the ingredient content of solutions can also be described in terms of weight/volume or % DS.

The term “% (w/v)” or “weight/volume %” refers to a concentration of a component in a solution or other liquid composition, or intended for addition to such compositions, expressed as weight per volume where the weight and volume are of the same metric category, e.g., gram per liter, milligram per milliliter and the units for this designation of concentration is wt/v % or “% (w/v).” Volume is the amount of liquid present in the composition but does not include solids. For example, 5 mg of rebaudioside A and 5 mg of rebaudioside M in 100 ml of water provides a 5% (w/v) of rebaudioside A. Such solution can also be described as being 10% (w/v) steviol glycoside. Similarly, if these amounts of steviol glycosides are dissolved in 90 ml of water and 10 ml of ethanol, the solution would still be 10% (w/v). In some aspects described herein, values of % w/v may be expected to be equivalent to wt % due to a small contribution of solute weight in the weight percent calculation and due to the density of water approximating 1 g/ml.

The term “% DS” or “% dissolved solids” refers to a concentration of dissolved components in a solution, or the amount being dissolved in solution in the context of an addition step, expressed as weight per volume where the weight and volume are of the same metric category, e.g., gram per liter, milligram per milliliter and the units for this designation of concentration is % DS, or in some cases % (w/v). While % DS refers expressly to dissolved solids, it can be understood in terms of total dissolved solid content or some subgroup therein. For example, a steviol glycoside solution can be described as having 3% DS for total steviol glycosides, 2% DS for rebaudioside M and rebaudioside A combined, and 1% DS for rebaudioside D. Alternatively, % (w/v) can be used: for example, total steviol glycosides at 3% (w/v), a combined concentration of rebaudioside M and rebaudioside A at 2% (w/v), and rebaudioside D at 1% (w/v).

The term “weight ratio” and “relative weight ratio” refers to the ratio of two ingredients by weight. For example, a steviol glycoside composition having a 1 g of rebaudioside M and 2 g of rebaudioside A could be described as having a weight ratio of 0.5 of rebaudioside M to rebaudioside A.

The term “aqueous solvent” and “aqueous solution” includes water, water solutions, and homogenous mixtures of miscible liquids that are predominantly water. For example, an aqueous solvent can be at least 50 wt %, 60 wt %, 70 wt %, 80 wt %, 90 wt %, 95 wt %, or 99 wt % water. The aqueous solvent can also be a non-alcohol aqueous solvent, which is substantially free of alcohol (0% alcohol), or contains less than 1 wt %, 0.5 wt %. 0.1 wt %, or less than detectable levels of alcohol. Buffer solutions and aqueous solutions containing preservatives are examples of aqueous solutions.

The term “alcohol” includes ethanol, but also includes other alcohols used as solvents. For example, alcohol can include C1-C4 alkyl alcohols. Alcohol can also include larger alcohols used as solvents solubilizing agents, such as C3-C4 alkyldiols, diethylene glycol, and Tris.

A “solution” refers, generally, to a solvent in which an ingredient is dissolved as a solute. Solutions exist as a dynamic equilibrium process, in which ingredients equilibrate between their dissolved phase and precipitated phase. This equilibrium process is dependent on temperature and the qualities of the dissolved material. For a given solution, the extent to which an ingredient is dissolved can change over time until reaching the point of equilibrium for a given temperature. Solutions can be stable or unstable. For example, solutions that are supersaturated or metastable can contain dissolved ingredients in amounts that are greater than are dissolved at the solution equilibrium. As such subsequent equilibrium will result in precipitation. Due to the temperature dependence of solution equilibrium, hot solutions may dissolve more material than the same solution when cold, and thus upon cooling precipitation will be induced, often in the form of crystallization. Because equilibration is time dependent, the stable concentration of a solution can be evaluated after a period of time to permit the solution to equilibrate to its stable equilibrium state. A stable solution at or near equilibrium can be identified when dissolved material shows minimal or no change in concentration, e.g., change of less than about 1% or less than about 5%, over a defined period at a given temperature. A stable solution can also be identified based on the absence of precipitation over a defined period of time, e.g., 72 hours, 7 days, 10 days, 14 days, 21 days, 40 days, etc., at a given temperature. In the same manner, a solution formulation lacking long-term stability, or having initial dissolved solid content at an amount greater than its equilibrium solubility, can be identified based on the appearance of precipitation over a defined period of time, e.g., 72 hours, 7 days, 10 days, 14 days, and 21 days, at a given temperature.

The presence, or absence, of “precipitation” or “precipitates” can be evaluated visually, with the unaided eye. Visible precipitates can take the form of solid particles, crystals, and/or turbidity. In various aspects, visible solid particles and crystals can have a diameter of at least 0.05 mm, 0.06 mm, 0.07 mm, 0.08 mm, 0.09 mm. 0.1 mm, 0.2 mm, 0.3 mm, 0.4 mm, 0.5 mm, 0.6 mm, 0.7 mm, 0.8 mm, 0.9 mm, or at least 1 mm. Turbidity is the cloudy, hazy, or murky appearance of suspended particles in a liquid. The appearance of turbidity can be evaluated visually by comparison to a freshly made sample having the same formulation (to identity appearance of new turbidity), or it can be evaluated by comparison to a standard having acceptable turbidity, such as purified drinking water. Turbidity can also be evaluated quantitatively using Formazin Attenuation Units (FAU) or Formazon Turbidity Units (FTU). In various aspects, a clear solution, free of visible turbidity may be defined as a turbidity value of 1 or less, 5 or less, or 8 or less in terms of FAU units or FTU units, which can be measured using light scattering techniques, such as the quantitative method set forth in ISO 7027-1:2016, which is incorporated by reference herewith in its entirety.

Dissolved solution content can be evaluated by percent recovery by separating the liquid from any particulate matter, using filtration if necessary, removing solvent, and measuring or analyzing the resulting solids Dissolved solution content can also be evaluated by separating the solution from any particular matter, using filtration if necessary, and subjecting the composition to standard quantitative chromatographic methods such as UHPLC.

“Solubility” refers, generally, to the ability and extent of an ingredient to dissolve, as solute, into a solvent to form a homogenous solution. In some contexts, the solubility of a given substance can be defined, for example, by way of the concentration of a saturated solution of the given substance in the solvent after the solution has reached equilibrium. (See, e.g., IUPAC. Compendium of Chemical Terminology, 2nd ed.). Solubility can be described in various expressions of concentration, e.g., wt % and % (w/v). Solution equilibrium can be determined by measuring change in precipitate or dissolved content.

“Dissolution” refers, generally, to the process of an ingredient dissolving, as solute, into a solvent to form a homogenous solution. Dissolution can be evaluated by visual monitoring for disappearance of solid ingredients, analogous to visual evaluation of precipitates.

The disclosure relates generally to methods of preparing steviol glycoside compositions having greater concentration of dissolved steviol glycosides and improved long-term solution stability. The disclosure also relates, generally, to rebaudioside M and rebaudioside A solutions, particles, aggregates, complexes, or compositions, defined by the stoichiometric or relative weight ratios described herein, which provide increased dissolution of steviol glycosides and improved long-term solution stability. The disclosure also relates to co-dried rebaudioside M and rebaudioside A formulations. In various aspects, the compositions comprise rebaudioside M and rebaudioside A at a relative weight ratio (M:A) about 0.2 to about 0.9, but the composition can also include other steviol glycosides. The disclosure further relates to methods of sweetening ingestible compositions.

### Steviol Glycosides

The present disclosure provides compositions containing a steviol glycoside component, which have improved aqueous solubility and provide a steviol glycoside solution having long-term stability. The steviol glycoside component of the present disclosure can contain a variety of steviol glycosides.

Steviol glycosides are a class of sweet-tasting glycosylated diterpene compounds commonly obtained from the leaves of Stevia rebaudiana. Various steviol glycosides are known, some of which provide a sugar-like taste profile and are 150 to 450 times sweeter than sugar. As such, steviol glycosides can be used at far lower concentrations than sugar in food and beverages. For example, in sugar-sweetened beverage, sugar may account for about 10 wt % of the total beverage composition (e.g., a sugary soda), whereas steviol glycosides used in place of sugar can provide equivalent sweetness at less than 0.07 wt % (less than 700 ppm) of the total beverage.

In some aspects, the term steviol glycoside refers to one or more of rebaudioside A (Reb A) (CAS #58543-16-1), rebaudioside B (Reb B) (CAS #58543-17-2), rebaudioside C (Reb C) (CAS #63550-99-2), rebaudioside D (Reb D) (CAS #63279-13-0), rebaudioside E (Reb E) (CAS #63279-14-1), rebaudioside F (Reb F) (CAS #438045-89-7), rebaudioside J (CAS #1313049-59-0), rebaudioside M (Reb M) (CAS #1220616-44-3), rubusoside (CAS #63849-39-4), dulcoside A (CAS #64432-06-0), rebaudioside 1 (Reb 1) (MassBank Record: FU000332), rebaudioside Q (Reb Q), rebaudioside N (Reb N: CAS #1220616-46-5), rebaudioside O (Reb O: CAS #1220616-48-7), rebaudioside DG (RebDG: see PCT Application No. PCT/US/2022/070906, filed Mar. 1, 2022, which is incorporated by reference herein in its entirety), 1,2-stevioside (CAS #57817-89-7), 1,3-stevioside (Reb G), steviol-1,2-bioside (MassBank Record: FU000299), steviol-1,3-bioside, steviol-13-O-glucoside (13-SMG), steviol-19-O-glucoside (19-SMG), OPS1-5 (corresponding to compound 4 from WO2016100689), steviol glycosides with 1, 2,3, 4, 5, 6, 7, 8, 9, 10 or more glycosides, isomers, and derivatives thereof. See, also, Steviol Glycosides Chemical and Technical Assessment 69th JECFA, 2007, prepared by Harriet Wallin, Food Agric. Org.

Exemplary steviol glycoside components include rebaudioside M, rebaudioside A, rebaudioside D. rebaudioside J. rebaudioside N. and rebaudioside O. In some aspects, one or more of the steviol glycoside components are produced by fermentation by an engineered microorganism. For example, rebaudioside D and M can be produced by an engineered organism and then isolated to produce a steviol glycoside component of primarily rebaudioside D and rebaudioside M as the predominant steviol glycoside species. Rebaudioside D and M can also be produced enzymatically from plant-derived steviol glycosides and further isolated. Rebaudiosides can be used in commercially available form, obtainable from Cargill, Inc. (Wayzata, MN), or purified before use.

Structurally, steviol glycosides comprise a steviol backbone and differ by the presence and arrangement of carbohydrate residues at the C13 and C19 positions of the steviol backbone. Not only do steviol glycosides differ structurally, but the various steviol glycosides also have differing physical and sensory properties.

Steviol glycosides generally exhibit poor aqueous solubility. For example, in water at 25° C., purified rebaudioside A can dissolve to achieve a dissolved content of about 0.8 wt % in aqueous solution at room temperature. (WO 2012/082587 A2) Yet other steviol glycosides which have relatively similar structures—have very different solubility properties. In aqueous solution at 25° C., conventional formulations of rebaudioside M can dissolve to about 0.1 wt % while formulations of rebaudioside D can dissolve to about 0.05 wt % (WO 2017/120480 A1). Commercially available steviol glycoside mixtures can also have poor aqueous solubility, for example, RM90 has a solubility of 0.14 wt %. The poor solubility of steviol glycosides remains even at higher temperatures: heating rebaudioside D in near boiling water for 2 hours will temporarily achieve dissolution to a concentration of only 0.8 wt %. The poor aqueous solubilities of rebaudiosides D. N, J, B. and E are shown in Example 1. below. Notably, even when dissolution of steviol glycoside in aqueous media is achieved, the resulting solution can be unstable and produce precipitation over time.

### Highly Soluble Steviol Glycoside Compositions

The present disclosure provides, in various aspects, methods of preparing steviol glycoside compositions having a greater concentration of dissolved steviol glycosides and having improved long-term solution stability. Highly concentrated steviol glycosides compositions are advantageous in food and beverage manufacturing due to having reduced volume of solvent, which leads to lower costs during manufacturing, shipping. and storage. Highly concentrated steviol glycoside solutions, as opposed to solids, have the advantage of offering liquid transfer and already containing solubilized steviol glycosides, thus simplifying use.

Steviol glycosides are used at various concentrations in food manufacturing. For example, a beverage may have a steviol glycoside concentration of about 0.001 wt % to about 0.1 wt % (i.e., 10 ppm to 1000 ppm), while flavoring syrups and frozen beverage concentrates that are typically diluted, e.g., 5:1, to provide an end product may have a steviol glycoside concentration of about 0.25 wt % to about 0.3%. However, such semi-concentrated products are not always easily obtained by conventional steviol glycoside compositions, due to the low aqueous solubility of steviol glycosides, which leads to troublesome dissolution and poor shelf life due to precipitate formation. Various methods and highly soluble steviol glycosides described herein provide a concentrate that can be easily and readily used by manufacturers for further preparation of semi-concentrated food and beverage intermediates.

The present disclosure provides highly concentrated steviol glycoside compositions, which have a dissolved steviol glycosides content of at least or about 1 wt %, 2 wt %, 3 wt %, 4 wt %, 5 wt %, or at least or about 10 wt % based on the total composition. Such highly concentrated compositions are especially useful for preparing less concentrated flavoring syrups and frozen beverage concentrates containing a steviol glycoside content of about 0.25 wt % to about 0.3%. Due to the low solubility of conventional formulations of steviol glycosides, such highly concentrated steviol glycoside solutions would typically not form in the first place, would suffer from poor shelf life and subsequent precipitation, or required use of additional components or undesirable process steps. In contrast, the present disclosure provides stable, highly concentrated steviol glycosides solutions, without requiring any additional solubilizing components or methods.

Surprisingly, steviol glycosides having improved solubility can be achieved by controlling the relative amounts of rebaudioside M and rebaudioside A in an aqueous solution, despite the fact that rebaudioside M and rebaudioside A each individually suffer from poor aqueous solubility. The use of these two components together at certain weight ratios results in a striking increase in net steviol glycoside solubility exceeding what would be expected from the solubility of either component alone.

The present disclosure provides highly soluble steviol glycoside compositions, and methods of making them, in which the steviol glycoside composition is formulated to contain rebaudioside M and rebaudioside A having a weight ratio (i.e., M/A Ratio), relative to each other, of about 0.15 to about 1.0. For example, there can be about 0.15 to about 1.0 parts rebaudioside M for each part rebaudioside A, by weight (i.e., 0.15:1 RebM:RebA to 1:1 RebM:RebA). In further aspects. the M/A Ratio is at least, about. or equal to 0.15. 0.2. 0.25. 0.30, 0.33. 0.35. 0.40. 0.45. 0.50, 0.55, 0.60, 0.65, 0.66, 0.70, or at least, about, or equal to 0.75. The M/A Ratio can be less than or about 1.33. 1.3, 1.2, 1.1, 1.05, 1.00, 0.99, 0.99, 0.98, 0.97, 0.96, 0.95, 0.94, 0.93, 0.92, 0.91, 0.90, 0.85, 0.80, 0.75, 0.70, 0.65, 0.60, 0.55, or less than or about 0.50. For example, the M/A Ratio can be about 0.2 to about 1, about 0.2 to about 0.9, about 0.2 to about 0.8, about 0.2 to about 0.7, about 0.2 to about 0.6.

Highly soluble steviol glycosides and concentrated steviol glycoside compositions can be prepared by mixing together water and a steviol glycoside composition having rebaudioside M and rebaudioside A at a relative weight ratio of about 0.15 to about 1.0. The mixing step can be performed at room temperature, or at a temperature between about 15° C. and about 30° C., or between about 20° C. to about 25° C. The resulting mixture is then heated up to a temperature of at least or about 65° C., 70° C., 75° C., 80° C., 85° C., or at least or about 90° C. Higher temperatures may also be used, for example, up to boiling water at atmospheric pressure, about 100° C. Heat can be applied, for example, by oven or heating block or in a heated mix tank. The heating process can take at least or about 1, 2. 3, 4, 5, 10, 15, 20, 30, 40, or at least or about 60 minutes. In some aspects, the mixture is heated for an additional period of time, such as at least or about 1, 2, 3, 4, 5. 10, 15, 20, 30, 40, or at least, about, or up to 60 minutes, after achieving the target temperature. During the heating period, the mixture is monitored for dissolution of all solid ingredients. In some aspects, the mixture is heated until complete dissolution is achieved. In further aspects, the mixture is heated for an additional period of time, such as at least or about 1, 2, 3, 4, 5, 10, 15, 20, 30, 40, or at least, about, or up to 60 minutes, after solid components have become completely dissolved. In total, the mixture may be maintained at a temperature of about, or between, 70° C., 72° C., 74° C., 76° C., 78° C., 80° C., 82° C., 84° C., 85° C., 86° C., or 88° C., for a period of at least or about 1, 2, 3, 4, 5, 10, 15, 20, 30, 40 or at least, about, or up to 60 minutes. After heating, the mixture is subsequently permitted to cool, which can be via external cooling or by thermal equilibration with room temperature or ambient air. In some aspects, the mixture is cooled to a temperature between about −10° C. and about 30° C., about −4° C. and about 25° C., about 0° C. and about 25° C., about 5° C. and 30° C., about 15° C. and about 25° C., or about 20° C. and 30° C.

In various aspects, the resulting solution is a stable, highly concentrated steviol glycoside aqueous solution. Thus, the present disclosure can provide a steviol glycoside concentrate, in the form of an aqueous solution, containing dissolved rebaudioside M and rebaudioside A at a combined concentration of at least 3 wt %, and having a relative weight ratio of 0.2 to 0.9, and having a total content of dissolved steviol glycosides of at least 5 wt % of the entire aqueous solution. These highly concentrated steviol glycoside solutions can provide convenience and cost savings for food and beverage manufacturers who can use it readily produce food and beverage compositions containing steviol glycosides using a solution without a requirement for further heat processing to achieve high steviol glycoside concentrations.

The steviol glycoside components, whether at the mixing step or in the resulting solution, can have a weight-volume concentration (based on volume of solvent) of at least or about 0.1%, 0.2%, 0.3%, 0.4%, 0.5%, 0.6%, 0.7%, 0.8%, 0.9%, 1.0%, 1.5%, 2.0%, 2.5%, 3%, 3.5%, 4%, 4.5%, 5%, 5.5%, 6%, 6.5%, 7%, 7.5%, 8%, 8.5%, 9%, 9.5%, 10%, 11%, 12%, 13%, 14%, 15%, 16%, 17%, 18%, 19%, 20%, 25%, 30%, 35%, 40%, or at least or about 45% (w/v). In various aspects, the concentration of steviol glycosides in the composition is up to about 3%, 3.5%, 4%, 4.5%, 5%, 5.5%, 6%, 6.5%, 7%, 7.5%, 8%, 8.5%, 9%, 9.5%, 10%, 15%, 20%, 25%, 30%, 35%, or up to about 40% (w/v). In some aspects, the weight-volume concentration of rebaudioside M, rebaudioside A, or the combined concentration of both, is at least or about 0.1%, 0.2%, 0.3%, 0.4%, 0.5%, 0.6%, 0.7%, 0.8%, 0.9%, 1.0%, 1.5%, 2.0%, 2.5%, 3%, 3.5%, 4%, 4.5%, 5%, 5.5%, 6%, 6.5%, 7%, 7.5%, 8%, 8.5%, 9%, 9.5%, 10%, 15%, 20%, 25%, 30%, 35%, 40%, or at least or about 45% (w/v). In various further aspects, the concentration of rebaudioside M, rebaudioside A, or the combined concentration of both, is up to about 3%, 3.5%, 4%, 4.5%, 5%, 5.5%, 6%, 6.5%, 7%, 7.5%, 8%, 8.5%, 9%, 9.5%, 10%, 15%, 20%, 25%, 30%, 35%, or up to about 40% (w/v). In various aspects, rebaudioside M and rebaudioside A, taken together, constitute at least or about, 10 wt %, 15 wt %, 20 wt %, 30 wt %, 40 wt %, 50 wt %, 60 wt %, 70 wt %, 80 wt %, 90 wt %, 95 wt %, 99 wt %, or at least or about 99.9 wt % of the total steviol glycoside content of the composition. Rebaudioside M and rebaudioside A, taken together, can constitute at least or about, 10 wt %, 15 wt %, 20 wt %, 30 wt %, 40 wt %, 50 wt %, 60 wt %, 70 wt %, 80 wt %, 90 wt %, 95 wt %, 99 wt %, or at least or about 99.9 wt % of the total dissolved solid content of the composition. Such concentrations refer to the weight of rebaudioside M and rebaudioside A in pure form. corrected to adjust for the pure rebaudioside M and rebaudioside A content in commercially available forms. For example, some commercially available forms of rebaudioside M contain about 91% rebaudioside M, while some forms of rebaudioside A contain about 60%, 80% or 95% of rebaudioside A.

As a further example, the amount of ingredients used in the methods, and the amount dissolved in the resulting solutions, can be at a concentration of least 1% (w/v). the steviol glycoside composition comprising rebaudioside M and rebaudioside A at a relative weight ratio of about 0.15 to about 1.0, and the combined concentration of rebaudioside M and rebaudioside A. together, is least 0.33% (w/v) of the steviol glycoside composition: heating the resultant combination at a temperature of 70° C. or greater, for at least 1 minute, and completely dissolving the steviol glycoside composition to provide a heated steviol glycoside solution; and then cooling the heated steviol glycoside solution to a temperature of 1-35° C. to provide the steviol glycoside concentrate. In another example, the steviol glycoside component is at least 5% (w/v), the steviol glycoside composition comprising rebaudioside M and rebaudioside A at a relative weight ratio of about 0.15 to about 1.0, and the combined concentration of rebaudioside M and rebaudioside A, together, is least 3% (w/v) of the steviol glycoside composition.

In further aspects, the steviol glycosides compositions can include other steviol glycosides, such as rebaudioside D, rebaudioside E, rebaudioside N, rebaudioside J, or a mixture thereof, which can alone or together can account for at least or about 0.1%, 0.2%, 0.3%, 0.4%, 0.5%, 0.6%, 0.7%, 0.8%, 0.9%, 1.0%, 1.5%, 2.0%. 2.5%, 3%, 3.5%, 4%, 4.5%, or at least or about 5% (w/v) of the aqueous mixture. In some aspects, rebaudioside D, rebaudioside E, rebaudioside N, rebaudioside J, or a mixture thereof, account for less than 0.1%, 0.2%, 0.3%, 0.4%, 0.5%, 0.6%, 0.7%, 0.8%, 0.9%, 1.0%, 1.5%, 2.0%, 2.5%, 3%, 3.5%, 4%, 4.5%, or less than 5% (w/v) of the aqueous mixture.

The presently described method and composition can provide, in various aspects, a concentrated and stable steviol glycoside solution, showing no visible precipitation after at least 7 days, at least 14 days, at least 21 days, at least 28 days, or at least 40 days at 22° C.

In various aspects, the concentrate comprises one or more steviol glycoside dissolved in an aqueous solution at a concentration higher than the concentration of the steviol glycoside alone in the same solution at the same temperature, by a factor of at least 100%, 200%, 300%, 400%, 500%, or at least 1000%. The steviol glycoside can be, for example, a combination of rebaudioside M and rebaudioside A, and may also additionally include rebaudioside D, rebaudioside N, rebaudioside O, rebaudioside DG, and/or rebaudioside J. In various further aspects, the aqueous composition containing rebaudioside M and rebaudioside A at a weight ratio of 0.2 to 0.9 maintains steviol glycosides in dissolved form for a longer period of time at a temperature of about −4° C. to about 30° C. than are obtained in the same solution and temperature, but lacking rebaudioside M, rebaudioside A, or lacking both. The solution can be stable for more than 1 day, 5 days, 7 days, 14 days, or 21 days.

In some aspects, the method can further involve a step of maintaining the resulting steviol glycoside solution at a temperature between 1° C. to 35° C. for at least 7 days, at least 14 days, at least 21 days. at least 28 days, or at least 40 days. The step can serve to mature the solution or to validate it. In further aspects, the method involves a validation step in which the steviol glycoside solution is validated by holding it at a temperature between 1° C. to 35° C. for at least 7 days, at least 14 days, at least 21 days, at least 28 days, or at least 40 days and confirming the absence of visible precipitation, or rejecting the batch if precipitation is present. Temperature may be maintained in a storage environment, shipping environment, or manufacturing environment. In various aspects, the steviol glycoside solution shows no visible precipitation, no turbidity, or neither, at a temperature between 1° C. to 35° C. for at least 7 days, at least 14 days, at least 21 days, at least 28 days, or at least 40 days.

The present disclosure further provides a method for making a highly soluble solid steviol glycoside compositions, which can be prepared by drying the various described steviol glycoside solutions containing rebaudioside M and rebaudioside A at a weight ratio of 0.2 to 0.9. Drying can be performed by flash freezing, then lyophilizing, or spray drying the composition to remove solvent.

For example, a highly soluble steviol glycoside product can be prepared combining a mixture of steviol glycosides containing rebaudioside M and rebaudioside A at a weight ratio of 0.2 to 0.9 in an aqueous solvent at room temperature. then heating the solution to a temperature of about 70° C. to about 90° C. for at least 1 minute, and dissolving the rebaudioside M and rebaudioside M to a concentration of at least 3 wt % and a total steviol glycoside concentration of at least 5 wt %, then cooling the heated temperature to room temperature, and then freeze drying and lyophilizing the composition to provide a dried steviol glycoside product.

Surprisingly, the resulting dried composition can be readily dissolved in aqueous solutions to achieve the same high concentrations achieved by the other presently described methods, but without requiring a heated solution. That is, the properties the steviol glycosides acquired during the heating and dissolution process remain despite removal of the solvent. Without intending to limit to any theory, one possible explanation is that the above-described thermal process produces a complex arrangement of rebaudioside M and rebaudioside A steviol glycosides that is highly soluble, and that even after such material dissolves into solution, the dissolved component remains sufficiently intact upon drying so as to retain its high solubility. Like the dissolved steviol glycosides in the above-described concentrates, the dried product contains rebaudioside M and rebaudioside A at a weight ratio of about 0.15 to about 1.0, about 0.2 to about 0.9, about 0.2 to about 0.7, or about 0.2 to about 0.6.

The dried composition can be used to obtain a highly concentrated aqueous solution having a combined rebaudioside M and rebaudioside A concentration of at least 3 wt % and a concentration of total dissolved steviol glycosides of at least 5 wt % by dissolving the composition in deionized water, at a temperature between 1° C. and 30° C., without requiring a heating step. The dried composition thus represents convenience and cost savings for food and beverage manufacturers (e.g., smaller packaging, reduced storage requirements, and potentially longer shelf life) who can use it to access highly soluble steviol glycosides using a solid composition without a requirement for heat processing.

The various compositions of the present disclosure can comprise a mixture of two or more steviol glycosides. The total concentration of steviol glycosides in the composition (i.e., based on the total weight of the composition as a whole, including solvent) can be at least or about 0.1 wt %, 0.2 wt %, 0.3 wt %, 0.4 wt %, 0.5 wt %, 0.6 wt %, 0.7 wt %. 0.8 wt %, 0.9 wt %, 1.0 wt %, 1.5 wt %, 2.0 wt %, 2.5 wt %, 3 wt %, 3.5 wt %, 4 wt %, 4.5 wt %, 5 wt %, 5.5 wt %, 6 wt %, 6.5 wt %, 7 wt %, 7.5 wt %, 8 wt %, 8.5 wt %, 9 wt %, 9.5 wt %, 10 wt %, 15 wt %, 20 wt %, 25 wt %, 30 wt %, 35 wt %, 40 wt %, or at least or about 45 wt %. In various aspects, total concentration of steviol glycosides in the composition is up to about 0.3 wt %, 0.4 wt %, 0.5 wt %, 0.6 wt %, 0.7 wt %, 0.8 wt %, 0.9 wt %, 1.0 wt %, 1.5 wt %, 2.0 wt %, 2.5 wt %, 3 wt %, 3.5 wt %, 4 wt %, 4.5 wt %, 5 wt %, 5.5 wt %, 6 wt %, 6.5 wt %, 7 wt %, 7.5 wt %, 8 wt %, 8.5 wt %, 9 wt %, 9.5 wt %, 10 wt %, 15 wt %, 20 wt %, 25 wt %, 30 wt %, 35 wt %, or up to about 40 wt % of the total composition. The total concentration of steviol glycosides in the composition can be, for example, about 0.3 wt % to 40 wt %, about 1 wt % to 20 wt %, about 2.5 wt % to 15 wt %, about 3 wt % to 5 wt %, about 3 wt % to 10 wt %, about 3 wt % to 20 wt %, about 4 wt % to about 20 wt %, about 5 wt % to about 10 wt %, about 5 wt % to about 15 wt %, about 5 wt % to 20 wt %, about 10 wt % to about 15 wt %, about 10 wt % to about 20 wt %. In various aspects, the entire amount of steviol glycosides is dissolved in aqueous solution.

The steviol glycoside component of the composition can have one steviol glycosides that predominates. For example, the steviol glycoside component of the composition can be predominantly rebaudioside A. The predominant steviol glycoside can account for at least or about 0.1 wt %, 0.2 wt %, 0.3 wt %, 0.4 wt %, 0.5 wt %, 0.6 wt %, 0.7 wt %. 0.8 wt %, 0.9 wt %, 1.0 wt %, 1.5 wt %, 2.0 wt %, 2.5 wt %, 3 wt %, 3.5 wt %, 4 wt %, 4.5 wt %, 5 wt %, 5.5 wt %, 6 wt %, 6.5 wt %, 7 wt %, 7.5 wt %, 8 wt %, 8.5 wt %, 9 wt %, 9.5 wt %, 10 wt %, 15 wt %, 20 wt %, 25 wt %, 30 wt %, 35 wt %, 40 wt %, or at least or about 45 wt % of the total composition. In various aspects, predominant steviol glycoside accounts for up to about 0.3 wt %, 0.4 wt %, 0.5 wt %, 0.6 wt %, 0.7 wt %. 0.8 wt %. 0.9 wt %. 1.0 wt %. 1.5 wt %, 2.0 wt %. 2.5 wt %. 3 wt %. 3.5 wt %, 4 wt %. 4.5 wt %. 5 wt %, 5.5 wt %, 6 wt %, 6.5 wt %, 7 wt %, 7.5 wt %, 8 wt %, 8.5 wt %, 9 wt %, 9.5 wt %, 10 wt %, 15 wt %, 20 wt %, 25 wt %, 30 wt %, 35 wt %, or up to about 40 wt % of the total composition. In some aspects, rebaudioside A is at least or about 45 wt %, 50 wt %, 55 wt %, 60 wt %, 65 wt %, 70 wt %, 75 wt %, or 80 wt % of the total steviol glycoside component of the composition. In some further aspects, rebaudioside A is less than or about 55 wt %, 60 wt %, 65 wt %, 70 wt %. 75 wt %, 80 wt %, 85 wt %, or less than or about 90 wt % of the total steviol glycoside component of the composition.

The steviol glycoside compositions described herein can contain rebaudioside D, which, in various aspects, can account for at least or about 0.05 wt %, 0.1 wt %, 0.2 wt %, 0.3 wt %, 0.4 wt %, 0.5 wt %, 0.6 wt %, 0.7 wt %, 0.8 wt %, 0.9 wt %, 1.0 wt %, 1.5 wt %, 2.0 wt %, 2.5 wt %, 3 wt %, 3.5 wt %, 4 wt %, 4.5 wt %, or at or about 5 wt % of the total composition, or of the total steviol glycoside component thereof. In some aspects, rebaudioside D is less than 0.1 wt %, 0.2 wt %, 0.3 wt %, 0.4 wt %, 0.5 wt %, 0.6 wt %, 0.7 wt %, 0.8 wt %, 0.9 wt %, 1.0 wt %, 1.5 wt %, 2.0 wt %, 2.5 wt %, 3 wt %, 3.5 wt %, 4 wt %, 4.5 wt %, or at or about 5 wt % of the total composition, or of the total steviol glycoside component thereof. In some aspects. rebaudioside D can account for at least, about, or less than 0.05%, 0.1%, 0.2%, 0.3%, 0.4%, 0.5%, 0.6%, 0.7%, 0.8%, 0.9%, 1.0%, 1.5%, 2.0%, 2.5%, 3%. 3.5%, 4%, 4.5%, or less than or about 5% (w/v) of the total composition. In various aspects, the rebaudioside D content is entirely dissolved in aqueous solution. The rebaudioside D can be present at about the same wt % as the rebaudioside A in the composition, rebaudioside M in the composition, or both. In some aspects, rebaudioside D can be present at weight ratio of at least or about 1:10, 1:5. 1:4, 1:3, 1:2, 2:1, 3:1, 4:1, or 5:1 with the amount of rebaudioside A in the composition, the amount of rebaudioside M in the composition, or both. In further aspects, rebaudioside D can be present at a weight ratio of no more than 1:4, 1:3, 1:2, 2:1, 3:1, 4:1, or 5:1 with the amount of rebaudioside A in the composition, the amount of rebaudioside M in the composition, or both.

The steviol glycoside compositions described herein can contain one or more of rebaudioside O, rebaudioside N, rebaudioside DG, or rebaudioside J, which can account alone or together, for at least or about 0.05 wt %, 0.1 wt %, 0.2 wt %, 0.3 wt %, 0.4 wt %, 0.5 wt %, 0.6 wt %, 0.7 wt %, 0.8 wt %, 0.9 wt %, 1.0 wt %, 1.5 wt %, 2.0 wt %, 2.5 wt %, 3 wt %, 3.5 wt %, 4 wt %, 4.5 wt %, or at or about 5 wt % of the total composition, or of the total steviol glycoside component thereof. In some aspects, one or more of rebaudioside O, rebaudioside N. rebaudioside DG, or rebaudioside J, is less than 0.1 wt %, 0.2 wt %, 0.3 wt %, 0.4 wt %, 0.5 wt %, 0.6 wt %, 0.7 wt %, 0.8 wt %, 0.9 wt %, 1.0 wt %, 1.5 wt %, 2.0 wt %, 2.5 wt %, 3 wt %, 3.5 wt %, 4 wt %, 4.5 wt %, 5 wt %, 5.5 wt %. 6 wt %. 6.5 wt %. 7 wt %. 7.5 wt %. 8 wt %. 8.5 wt %. 9 wt %. 9.5 wt %, or less than 10 wt % of the total composition, or of the total steviol glycoside component thereof. In some aspects. one or more of rebaudioside O, rebaudioside N, rebaudioside DG, or rebaudioside J can account for at least, about, or less than 0.05%, 0.1%, 0.2%, 0.3%, 0.4%, 0.5%, 0.6%. 0.7%, 0.8%, 0.9%, 1.0%, 1.5%, 2.0%, 2.5%, 3%, 3.5%, 4%, 4.5%, 5%, 6%, 7%, 8%, or 9%, or less than or about 10% (w/v) of the total composition. In various aspects, the rebaudioside O, rebaudioside N, rebaudioside DG, and rebaudioside J, if present, is entirely dissolved in aqueous solution. The rebaudioside O, rebaudioside N, rebaudioside DG, or rebaudioside J, or any combination thereof, can be present at about the same wt % as the rebaudioside A in the composition, rebaudioside M in the composition, or both. In other aspects, rebaudioside O, rebaudioside N, rebaudioside DG, or rebaudioside J, or any combination thereof can be present at weight ratio of at least or about 1:10, 1:5, 1:4, 1:3, 1:2. 2:1, 3:1, 4:1, or 5:1 with the amount of rebaudioside A in the composition, the amount of rebaudioside M in the composition, or both.

In various aspects, the composition is substantially free of one or more of steviolbioside, rebaudioside B, rebaudioside C, rebaudioside E, or rebaudioside F. In further aspects, steviolbioside, rebaudioside B, rebaudioside C, rebaudioside E, or rebaudioside F, alone, together, or any combination thereof, is present in an amount less than 0.01 wt %, 0.02 wt %, 0.03 wt %, 0.04 wt %, 0.05 wt %, 0.06 wt %, 0.07 wt %, 0.08 wt %, 0.09 wt %, 0.1 wt %, 0.2 wt %, 0.3 wt %, 0.4 wt %, 0.5 wt %, 0.6 wt %, 0.7 wt %, 0.8 wt %, 0.9 wt %, 1.0 wt %, 1.5 wt %, 2.0 wt %, 2.5 wt %, 3 wt %, 3.5 wt %, 4 wt %, or 4.5 wt %, or at least or about 5 wt % of the total composition, or of the total steviol glycoside component thereof. The composition may be free of (0 wt %) one or more of steviolbioside, rebaudioside B, rebaudioside C, rebaudioside E, or rebaudioside F. In some aspects, one or more of rebaudioside O, rebaudioside N, rebaudioside DG, or rebaudioside J, alone or together, can account for about, or less than 0.05%, 0.1%, 0.2%, 0.3%, 0.4%, 0.5%, 0.6%, 0.7%, 0.8%, 0.9%, 1.0%, 1.5%, 2.0%, 2.5%, 3%, 3.5%, 4%, 4.5%, or less than or about 5% (w/v) of the total composition. The composition may be free of (0) wt %) one or more of rebaudioside E, rebaudioside N, or rebaudioside J.

### Solubility Enhancers

Various compositions of the present invention can obtain high aqueous solubility of steviol glycosides without requiring solubility enhancers, alcohol, steviol glycoside malonic esters, or other solubilizers. The present invention is advantageous over compositions that require solubility enhancers and other solubilizers in that the addition of said solubility enhancers and solubilizers may be associated with undesirable color changes in the steviol glycoside solutions. Thus, the composition can be substantially free of such compounds or may comprise such compounds in an amount below the amount which imparts solubilizing effects. The steviol glycoside compositions described herein can be free of alcohol (0%). For example, the steviol glucoside compositions can comprise less than 5 wt %, 4 wt %, 3 wt %, 2 wt %, 1 wt %, 0.5 wt %, 0.1 wt %. or less than 0.05 wt % alcohol, e.g., ethanol. The steviol glycoside compositions described herein can be free of any solubility enhancer (0%). For example, the steviol glycoside composition can have less than 5 wt %, 4 wt %, 3 wt %, 2 wt %, 1 wt %, 0.5 wt %, 0.1 wt %, or less than 0.05 wt % of solubility enhancers. The solubility enhancer may be, e.g., the total of caffeic acid, esters of caffeic acid, esters of caffeic acid and quinic acid, ferulic acid, esters of ferulic acid, esters of ferulic acid and quinic acid, 3-(3,4-dihydroxyphenyl) lactic acid, esters of 3-(3,4-dihydroxyphenyl) lactic acid, quinic acid, esters of quinic acid, p-coumaric acid, esters of p-coumaric acid, esters of p-coumaric acid and quinic acid, sinapic acid, esters of sinapic acid, esters of sinapic acid and quinic acid, tartaric acid, esters of tartaric acid, and naturally obtained compositions containing any combination thereof. Some aspects include no added solubility enhancers or are substantially free of solubility enhancers.

### Sweetened Compositions

The present disclosure also provides methods of making a sweetened compositions and compositions arising therefrom. The sweetened composition may be, for example, a sweetener or a sweetened composition such as a food, a beverage syrup concentrate, a sweetened beverage, a carbonated soft drink. a pharmaceutical composition, a nutritional supplement, or a dental composition. If the sweetened composition is a sweetener, it may include one or more additional nutritive or non-nutritive sweetener, such as sugar, mogrosides, aspartame, or sucralose. Suitable beverage concentrates include throw syrups, which can be used in making fountain drinks or bottled beverages, and liquid water enhancers, which are typically concentrated flavor systems consumers can add to water. Toothpaste is one suitable dental composition.

The steviol glycosides compositions described herein can be incorporated into any edible material or other composition intended to be ingested and/or contacted with the mouth of a human or animal, such as, for example, pharmaceutical compositions, edible gel mixes and compositions, dental and oral hygiene compositions, foodstuffs (confections, condiments, chewing gum, cereal compositions, baked goods, baking goods, cooking adjuvants, dairy products, and tabletop sweetener compositions), beverages, and other beverage products (e.g., beverage mixes. beverage concentrates, etc.). Examples of such ingestible compositions and aspects thereof are set forth in WO 2019/071220 A1, WO 2019/071182 A1, U.S. application Ser. No. 16/373,206, and U.S. application Ser. No. 16/374,422, each of which is incorporated by reference herein in their entirety.

The sweetenable composition, or ingestible composition, can be a beverage. As used herein a “beverage product” includes a ready-to-drink beverage, a beverage syrup, frozen beverage, or a powdered beverage. Suitable ready-to-drink beverages include carbonated and non-carbonated beverages. Carbonated beverages include, but are not limited to, enhanced sparkling beverages, cola, lemon-lime flavored sparkling beverage, orange flavored sparkling beverage, grape flavored sparkling beverage, strawberry flavored sparkling beverage, pineapple flavored sparkling beverage, ginger-ale, soft drinks and root beer. Non-carbonated beverages include, but are not limited to fruit juice, fruit-flavored juice. juice drinks, nectars. vegetable juice, vegetable-flavored juice, sports drinks, energy drinks, enhanced water drinks, enhanced water with vitamins, near water drinks (e.g., water with natural or synthetic flavorants), coconut water, tea type drinks (e.g. black tea. green tea, red tea, oolong tea), coffee, cocoa drink, beverage containing milk components (e.g. milk beverages, coffee containing milk components, cafe au lait, milk tea, fruit milk beverages). beverages containing cereal extracts, smoothies and combinations thereof. Examples of frozen beverages include, but are not limited to, icees, frozen cocktails, daiquiris, pina coladas, margaritas, milk shakes, frozen coffees, frozen lemonades, granitas, and slushees.

Beverages can suitably contain a steviol glycosides, as sweetener. in an amount ranging from about 1 ppm to about 1,000 ppm, such as, for example, from about 25 ppm to about 800 ppm. In another embodiment, steviol glycosides are present in the beverage in an amount ranging from about 100 ppm to about 600 ppm. In yet other aspects, steviol glycosides are present in the beverage in an amount ranging from about 100 to about 200 ppm, from about 100 ppm to about 300 ppm. from about 100 ppm to about 400 ppm, or from about 100 ppm to about 500 ppm. In still another embodiment, steviol glycosides are present in the beverage in an amount ranging from about 300 to about 700 ppm, such as, for example, from about 400 ppm to about 600 ppm. In a particular embodiment, steviol glycosides are present in the beverage in an amount of about 500 ppm.

Beverage syrups can suitably contain a steviol glycosides, as sweetener, in an amount ranging from about 5 ppm to about 10,000 ppm, such as, for example, from about 125 ppm to about 8000 ppm. In another aspect, steviol glycosides are present in the beverage syrups in an amount ranging from about 500 ppm to about 6000 ppm. In yet other aspects, steviol glycosides are present in the beverage in an amount ranging from about 800 to about 5000 ppm, from about 2000 ppm to about 4000 ppm. or from about 2000 ppm to about 3000 ppm. Beverage syrups can be prepared with an initial volume of liquid matrix (e.g., water) and the desired beverage ingredients. Full strength beverages are then prepared by adding further volumes of water. Powdered beverages are prepared by dry-mixing all of the beverage ingredients in the absence of a liquid matrix. Full strength beverages are then prepared by adding the full volume of water.

Beverage and food sweetener concentrates, for use as a concentrated sweetener source in food and beverage manufacturing, can suitably contain a steviol glycosides in an amount ranging from at least or about 3 wt %, 4 wt %, 5 wt %, 6 wt %, 7 wt %, 8 wt %, 9 wt %, 10 wt %, 11 wt %, 12 wt %, 13 wt %, 14 wt %, 15 wt %, 16 wt %, 17 wt %, 18 wt %, 19 wt %, or at least or about 20 wt %.

The terms and expressions that have been employed are used as terms of description and not of limitation, and there is no intention in the use of such terms and expressions of excluding any equivalents of the features shown and described or portions thereof, but it is recognized that various modifications are possible within the scope of the embodiments of the present disclosure. Thus, it should be understood that although the present disclosure has been specifically disclosed by specific embodiments and optional features, modification and variation of the concepts herein disclosed may be resorted to by those of ordinary skill in the art, and that such modifications and variations are considered to be within the scope of embodiments of the present disclosure.

### EXAMPLES

The following examples are provided to illustrate the disclosure but are not intended to limit the scope thereof. All parts and percentages are by weight unless otherwise indicated.

### Materials and Methods

Solutions were prepared by mixing one or more steviol glycoside component in purified water at ambient temperature. Solubility enhancers, preservatives, or ethanol were included only where expressly indicated and, when used, were added to the initial mixture prior to heating and dissolution. The mixtures were premixed and then subsequently heated via heat block or oven. Solutions took approximately one or two minutes to reach the target temperature, and then were maintained at the target temperature at least until complete dissolution of solids. Dissolution of solids was monitored visually during heating. After the heating period, fully dissolved solutions were permitted to cool to room temperature and were monitored for initial precipitation.

Solutions were further monitored for stability over periods of hours, days, weeks, and longer. Multiple techniques were utilized to evaluate stability. Visual observation was relied upon to identify the time in which precipitation began to occur, including formation of crystals, or increased turbidity, thus indicating that the solution had become unstable. Solutions were also evaluated by recovering dissolved solids and then calculating percent recovery. If necessary, the solutions were filtered to remove undissolved material to assure that percent recovery reflected only dissolved steviol glycosides.

Percent dissolved solids (% DS) refers to weight/volume of total dissolved steviol glycosides or particular components, as indicated.

The ratio of rebaudioside M to rebaudioside A (M/A ratio) is adjusted to correct for component amounts in different sources. For example, a mixture of about 1 mg of RM01 and about 1 mg of RA95, would have a M/A ratio of about 0.97.

TABLE 1

| Component | Ingredients | Source |
|---|---|---|
| rebaudioside A | about 96 wt % rebaudioside A | Cargill, Inc. |
| (RA95) | | (Wayzata, MN) |
| rebaudioside A | about 80 wt % rebaudioside A | |
| (RA80) | | |
| rebaudioside A | about 62 wt % rebaudioside A | |
| (RA60) | | |
| rebaudioside M | about 91 wt % rebaudioside M | |
| (RM01) | | |
| rebaudioside M | about 73 wt % rebaudioside M | |
| (RM02) | | |
| Preservatives | Sodium benzoate and potassium | Sigma Aldrich |
| | sorbate to a provide a combined | (St. Louis, MO) |
| | aqueous concentration of 1500 ppm. | |

### Example 1: Evaluation of Steviol Glycoside Solubility

Various individual steviol glycosides were tested to evaluate initial solubility in aqueous solution as well as the long-term stability in solution. Ingredients were combined in purified water at room temperature then heated to 85° C. with a heating block to effect dissolution.

In the tables of this Example, below, the listed steviol glycosides in purified form provided the entire amount of dissolved solids, except that solubility enhancers were used where expressly noted.

TABLE 2
Solubility and Long-term Stability of Single Steviol Glycosides

| Steviol Glycoside | % DS | Soluble? | Crystallization Time | |
|---|---|---|---|---|
| D | 0.48% | Y | <2 | hrs |
| N | 0.49% | Y | <1 | hrs |
| J | 0.53% | Y | <2 | hrs |
| B | 0.47% | N | Immediate | |
| E | 0.49% | Y | 14 | days |
| M (RM01) | 0.33% | Y | <3 | days |

The tested rebaudiosides D, N, J, B, and E were laboratory purified samples. Although each of the rebaudioside D, N, J, E, and M solutions fully dissolved under the test conditions, each solution subsequently suffered from dissolved steviol glycosides precipitating or crystallizing out of the solution, generally within hours. The rebaudioside B mixture and the 1% solution of rebaudioside J failed to dissolve under the test conditions. These results emphasize that initial solubility of a steviol glycoside solution does not necessarily reflect long-term stability of the solution. The results also show that all the tested steviol glycosides are vulnerable to precipitation over time, with initial solutions of rebaudioside D, N, and J showing little ability to maintain dissolution, even at low concentrations.

### Example 2: Evaluation of Rebaudioside M and Rebaudioside A Steviol Glycoside Pair

The pair of rebaudioside M and A was tested to evaluate initial solubility in aqueous solution as well as the long-term stability in solution. Ingredients were combined in purified water at room temperature then heated to 85° C. with a heating block to effect dissolution.

Initial tests were performed on 1% and 2% concentration solutions of the M and A blends. The blend was prepared from an approximately 1:1 mixture, by weight, of laboratory purified steviol glycosides and purified water. In Table 3, the listed steviol glycosides in purified form provided the entire amount of dissolved solids.

TABLE 3
Two Week Stability Test of Steviol Glycoside Pairs (1% DS)

| Steviol Glycoside | | | |
|---|---|---|---|
| Pair (approx. 1:1 | % DS | | Appearance At |
| mixture by weight) | (approx.) | Soluble? | Two Weeks |
| M/A | 1% | Y | Clear, No Visible |
| | | | Precipitation |
| M/A | 2% | Y | Clear, No Visible |
| | | | Precipitation |

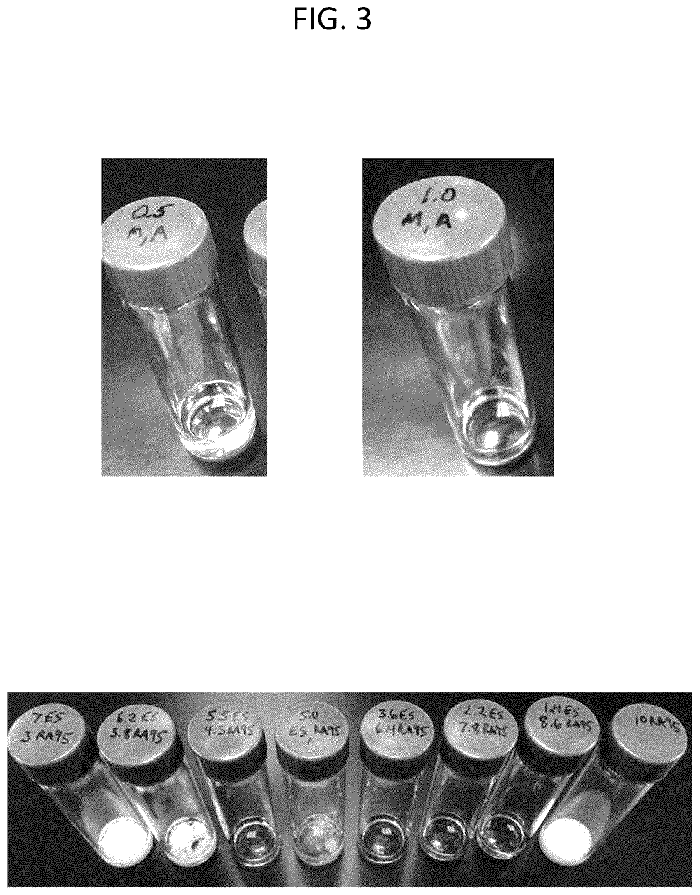

FIG. 3 (top: left and right) shows photographs of the results of this trial. At both 1% and 2% concentrations, the combination of rebaudioside M and rebaudioside A provided a clear, colorless solution that was free of any visible precipitate.

In comparison with Example 1, these results first show that a mixture of rebaudioside M and A can achieve greater amounts of dissolved steviol glycoside solids (% DS) than would otherwise be obtainable if dissolving the individual steviol glycosides. Moreover, the binary blend of rebaudioside M and rebaudioside A appears to provide a stabilizing effect on the resulting solution that persists for at least two weeks. For comparison, solutions of individual rebaudiosides M and A alone each precipitate within a week at lower concentrations. A solution of 1% rebaudioside M crashes out in less than an hour, and a solution of 1% rebaudioside A crashes out within 72 hours.

The rebaudioside M and A blend was further observed hourly for the first several hours, then monitored daily to evaluate long-term stability. Steviol glycoside binary blends in aqueous solvent (1%) were prepared from as an approximately 1:1 mixture, by weight, of laboratory purified steviol glycosides and purified water.

TABLE 4
Evaluation of Long-term Stability of
Different Steviol Glycoside Pairs

| Steviol Glycoside Pair | % DS | Soluble? | Crystallization Time |
|---|---|---|---|
| M/A | 1.03% | Y | 17 days |

Surprisingly, the stability of the resulting solutions does not seem to be based on the solubility of the individual ingredients. For example, the combination of rebaudiosides M and A, which are each individually poorly soluble steviol glycosides, resulted in a solution that shows vastly improved long-term stable.

### Example 3: Effect of Rebaudioside M and Rebaudioside A Ratio

Aqueous solutions containing rebaudioside M and rebaudioside A were prepared and tested to evaluate the effect of the weight ratio of rebaudioside M to rebaudioside A (M/A ratio) on initial solubility and the long-term stability of the resulting solution.

Steviol glycoside mixtures were prepared from different commercially available rebaudioside sources, namely, RM01 (having about 91 wt % Reb M), RM02 (having about 73 wt % Reb M), RA95 (having about 96 wt % Reb A), and RA80 (having about 80 wt % Reb A), obtained from Cargill, Inc. (Wayzata, MN). The provided M/A ratio is calculated after adjusting for actual rebaudioside M and rebaudioside A content in the source material. In the tables of this Example, commercially available rebaudioside M and rebaudioside A mixtures provided the entire amount of dissolved solids. No solubility enhancers or other dissolved solids were used except where expressly noted.

Amounts of rebaudioside M and rebaudioside A in varying ratios were combined with purified water at room temperature and then heated to 85° C. with a heating block to effect dissolution. For example, for batches formulated to provide a concentration of about 10% DS, approximately 25 mg of each of rebaudioside M and rebaudioside A were dissolved in 500 μL of purified water. Samples were monitored until crystallization occurred or for at least 40 days. Solutions that remained clear and free of visible precipitation are identified in the tables below.

TABLE 5
Evaluation of rebaudioside M/A Ratio in 10%
Steviol Glycoside Solution of RM01 and RA95

| % DS | M/A Ratio | Soluble? | Crystallization Time | |
|---|---|---|---|---|
| 9.88% | 3.83 | Y | <1 | hr |
| 10.08% | 3.07 | Y | <2 | days |
| 10.02% | 2.76 | Y | <2 | days |
| 10.36% | 2.12 | Y | <2 | days |
| 10.78% | 1.44 | Y | 6 | days |
| 10.00% | 1.16 | Y | 13 | days |
| 9.90% | 0.53 | Y | No Visible Precipitation at 40 days | |
| 10.02% | 0.27 | Y | No Visible Precipitation at 40 days | |
| 9.98% | 0.15 | Y | No Visible Precipitation at 40 days | |
| 9.96% | 0 | Y | <3 | days |

FIG. 3 provides a photograph of these results (bottom photograph). In the photograph, the mixture on the far right was made from only rebaudioside A (10 mg), showing intense precipitation, while the other mixtures were prepared as a mixture of rebaudioside M and A. The samples, from left to right, were based on the following unadjusted M/A weight ratios of commercial-available rebaudioside M and rebaudioside A: 7/3, 6.2/3.8, 5.5/4.5, 5/5, 3.6/6.4, 2.2/7.8, and 1.4/8.6. Mixtures having an M/A ratio of 0.53 to 0.15 provided a clear, colorless solution free of visible precipitation. All other mixtures have visible precipitation and murkiness (turbidity), with a greater amount of rebaudioside M resulting in greater precipitation. Although difficult to ascertain from the photograph, the sample having labeled 5.5/4.5 contained small microcrystals.

TABLE 6
Evaluation of rebaudioside M/A Ratio in 5% Steviol
Glycoside Solution* of RM01 and RA95

| % DS | M/A Ratio | Soluble? | Crystallization Time | |
|---|---|---|---|---|
| 5.06% | 2.21 | Y | 1 | day |
| 5.10% | 1.38 | Y | 7 | days |
| 5.06% | 0.90 | Y | 14 | days |

| | | | |
|---|---|---|---|
| 4.98% | 0.59 | Y | No Visible Precipitation |
| 5.00% | 0.24 | Y | No Visible Precipitation |

*Each sample further contains 1500 ppm benzoate/sorbate preservative

TABLE 7
Evaluation of rebaudioside M/A Ratio in 1%
Steviol Glycoside Solution of RM01 and RA95

| % DS | M/A Ratio | Soluble? | Crystallization Time | |
|---|---|---|---|---|
| 0.99% | 3.83 | Y | 5 | days |
| 0.99% | 1.79 | Y | 20 | days |
| 0.98% | 0.94 | Y | 25 | days |

| | | | |
|---|---|---|---|
| 1.00% | 0.46 | Y | No Visible Precipitation |
| 1.01% | 0.24 | Y | No Visible Precipitation |

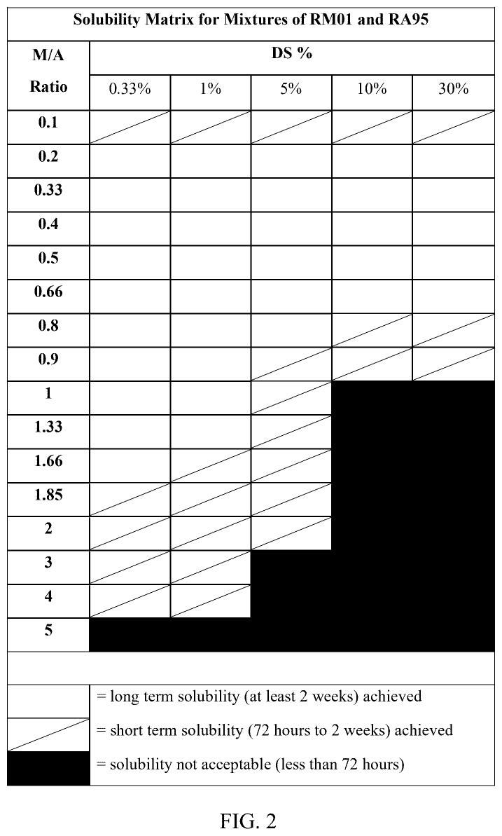

The results of various trials utilizing RM01 and RA95 were compiled to provide FIG. 2, which is a matrix comparing M/A ratio to total steviol glycoside concentration. The matrix suggests that a M/A ratio between about 0.2 and about 0.9 may be optimal for 5% DS solutions. Less concentrated solutions may permit a wider M/A range, whereas more concentrated solutions obtain best results with a narrower M/A ratio, such as between about 0.2 and about 0.8 or between about 0.2 and 0.66.

TABLE 8
Evaluation of rebaudioside M/A Ratio in 5%
Steviol Glycoside Solution of RM01 and RA80

| % DS | M/A Ratio | Soluble? | Crystallization Time | |
|---|---|---|---|---|
| 4.95% | 2.61 | Y | <1 | hr |
| 4.98% | 1.66 | Y | <1 | hr |
| 5.05% | 1.08 | Y | 34 | days |
| 4.95% | 0.72 | Y | 40 | days |

| | | | |
|---|---|---|---|
| 5.03% | 0.29 | Y | No Visible Precipitation |

TABLE 9
Evaluation of rebaudioside M/A Ratio in 1%
Steviol Glycoside Solution of RM01 and RA80

| % DS | M/A Ratio | Soluble? | Crystallization Time | |
|---|---|---|---|---|
| 1.01% | 4.57 | Y | 3 | days |
| 1.00% | 2.14 | Y | 8 | days |
| 1.03% | 1.18 | Y | 40 | days |

| | | | |
|---|---|---|---|
| 0.99% | 0.49 | Y | No Visible Precipitation |
| 1.01% | 0.29 | Y | No Visible Precipitation |

TABLE 10
Evaluation of rebaudioside M/A Ratio in 1%
Steviol Glycoside Solution of RM02 and RA95

| % DS | M/A Ratio | Soluble? | Crystallization Time | |
|---|---|---|---|---|
| 1.02% | 3.02 | Y | 5 | days |
| 1.05% | 1.46 | Y | 11 | days |

| | | | |
|---|---|---|---|
| 1.02% | 0.83 | Y | No Visible Precipitation |
| 1.00% | 0.38 | Y | No Visible Precipitation |
| 1.01% | 0.18 | Y | No Visible Precipitation |

Overall, these results show that the relative amount of rebaudioside M and rebaudioside A has a significant effect on long-term stability of aqueous steviol glycosides. These results also show that an M/A ratio of about 0.2 to about 0.9 will reliably provide an aqueous steviol glycosides solution that remains stable in solution for at least two weeks, potentially indefinitely. These results were observed even in compositions containing higher concentrations of steviol glycosides and using various sources of rebaudioside M and rebaudioside A.

### Example 4: Effect of Freezing on Long Term Stability of Rebaudioside M/A Solutions

Steviol glycoside solutions of rebaudioside M and rebaudioside A were tested to determine if the steviol glycosides remained dissolved through freezing. Ingredients were combined in purified water at room temperature then heated to 85° C. with a heating block to effect dissolution. The solution was then allowed to cool to ambient temperature before subsequently subjecting it to freezing. Solutions were visually monitored for precipitation during freezing and thawing, and then further monitored daily for at least 46 days.

TABLE 11
Effect of Freezing on Steviol Glycoside
Solutions of RM01 and RA95

| | | Stayed in | | |
|---|---|---|---|---|
| | | solution through | | |
| % DS | M/A Ratio | freeze? | Crystallization Time | |
| 0.35% | 0.84 | Y | No Visible Precipitation | |
| 1.01% | 0.91 | Y | 46 | days |
| 4.88% | 0.99 | Y | <3 | days |

These results show that steviol glycoside solutions having an M/A ratio of less than 1 can survive freezing without undergoing precipitation. The results also show that an M/A ratio of about 0.9 or less can undergo freezing and nonetheless provide a solution having long-term stability for at least 40 days, and potentially indefinitely.

### Example 5: Effect of Alcohol on Long Term Stability of Rebaudioside M/A Solutions

Steviol glycoside solutions of rebaudioside M and rebaudioside A were tested to determine if non-aqueous solvent was beneficial or detrimental to solution stability. Ingredients were combined in purified water at room temperature then heated to 85° C. with a heating block to effect dissolution. The solution was allowed to cool to ambient temperature, and then visually monitored for precipitation.

TABLE 12
Effect of Alcohol on Steviol Glycoside
Solutions of RM01 and RA95

| | | EtOH | | |
|---|---|---|---|---|
| % DS | M/A Ratio | Content % | Crystallization Time | |
| 5.06% | 0.90 | 0 | 14 | days |
| 4.94% | 0.94 | 5 | 5 | days |
| 4.92% | 0.95 | 10 | <3 | days |
| 4.93% | 0.95 | 20 | <1 | day |
| 5.05% | 0.92 | 40 | 4 | days |

These results show that inclusion of ethanol is detrimental on long-stability, although the effect is not directly linear, appearing to change course at around 40% ethanol. As such, alcohol contaminants or additives can be minimized or eliminated to achieve steviol glycoside solutions that exhibit long-term stability and resistance to precipitation.

### Example 6: Effect of Rebaudioside M/a Mixture on the Solubility of Total Glycosides

Steviol glycoside solutions of rebaudioside M and rebaudioside A were tested to determine if the beneficial solubilizing effect of the rebaudioside M and rebaudioside A mixtures could serve to help solubilize other steviol glycosides. Ingredients were combined in purified water at room temperature then heated to 85° C. with a heating block to effect dissolution. The solution was allowed to cool to ambient temperature, and then visually monitored for precipitation.

TABLE 13
Effect of rebaudioside M/rebaudioside A Pair on Total Steviol Glycosides

| Steviol | M/A | % DS | % DS | M/A to Total | | Crystallization |
|---|---|---|---|---|---|---|
| Glycosides | Ratio | (M + A) | (Total) | Glycoside Ratio | Soluble? | Time |
| M, D, A | 0.94 | 1.05% | 1.55% | 0.68 | Y | 26 days |
| M, D, A | 1.13 | 2.00% | 3.10% | 0.68 | Y | 20 days |
| M, D, N, J, A | 0.86 | 2.16% | 5.20% | 0.42 | Y | |
| M, D, N, J, A | 1.04 | 4.36% | 10.32% | 0.42 | Y | 57 days |

These results show that the combination of rebaudioside M and rebaudioside A can increase the total amount steviol glycosides dissolved in solution, even when the M/A combination represents less than half of the total steviol glycoside mixture. These results also show that an approximately 1:1 ratio or less of rebaudioside M and rebaudioside A may serve to assist in maintaining dissolution of other steviol glycosides, such as rebaudioside D, N, and J.

### Example 7: Effect of Rebaudioside M/A Mixture on the Solubility of Rebaudioside D

Various mixtures of rebaudioside D were tested to evaluated initial solubility in aqueous solution as well as the long-term stability in solution. Ingredients were combined in purified water at room temperature then heated to 85° C. with a heating block to effect dissolution.

Each mixture used of steviol glycosides in substantially equal parts, by weight, using laboratory purified steviol glycosides in purified water. In the tables of this Example, the listed steviol glycosides in purified form provided the entire amount of dissolved solids. Rebaudioside M and rebaudioside A were used in an approximately 1:1 weight ratio, unadjusted. No solubility enhancers or other dissolved solids were used except where expressly noted.

TABLE 14
Effect of Rebaudioside M/Rebaudioside
A Pair on Rebaudioside D Solubility

| Steviol | % DS | % DS | | Crystallization | |
|---|---|---|---|---|---|
| Glycosides | (Reb D) | (Total) | Soluble? | Time | |
| D | 0.48% | 0.5% | Y | <2 | hrs |
| D/M | 0.54% | 1.0% | Y | 8 | days |
| D/A | 0.47% | 1.0% | Y | <3 | hrs |
| D/M/A | 0.50% | 1.55% | Y | 26 | days |
| D/M/A | 1.10% | 3.10% | Y | 20 | days |
| D/M/A | 1.58% | 4.92% | Y | <4 | hrs |

| | | | | |
|---|---|---|---|---|
| D/M/A | 1.90% | 5.90% | N | n/a |

These results show that the combination of rebaudioside M and rebaudioside A can, together, increase the amount rebaudioside D dissolved in solution and improve long-term stability of the resulting solution. This result is especially surprising given that combination of rebaudioside D with only rebaudioside M, only rebaudioside A, or only solubility enhancer, shows minimal advantages. Without intending to be limited by theory, it is thought that the highly soluble M/A material may help to solubilize or “pull” the rebaudioside D into solution.

Although showing improvements to solubility. higher concentrations of rebaudioside D remained challenging to dissolve and keep in solution. One mixture, containing 1.90% dissolved rebaudioside D and 5.9% total dissolved steviol glycosides did not fully dissolve into solution during initial dissolution, while another mixture containing slightly less rebaudioside D and total steviol glycosides was able to be dissolved, but subsequently crystallized within 4 hours at room temperature.

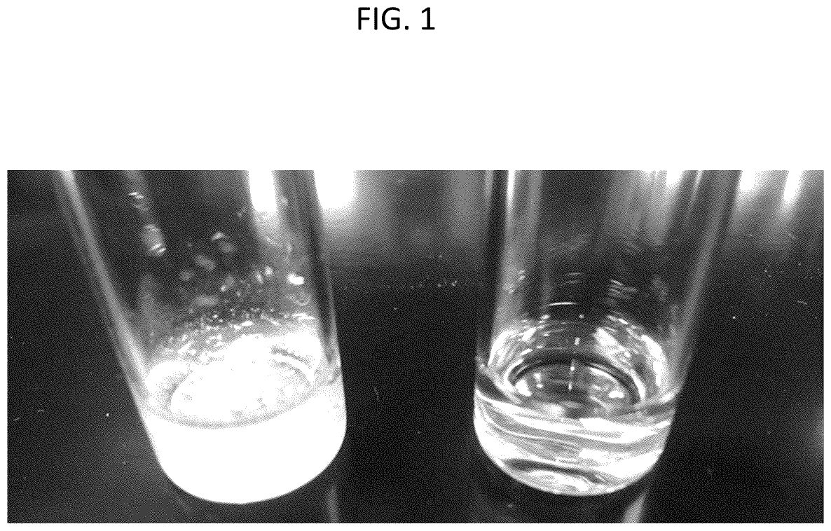

Lastly, FIG. 1 shows a similar comparison between a mixture of 1% rebaudioside D in water (on the right), which failed to dissolve during heating, and a mixture of 1% rebaudioside D together with 1% each of rebaudioside M and rebaudioside A (on the left). The combined mixture is clear and free of precipitation.

### Example 8: Evaluating Long-Term Solution Stability

Steviol glycoside solutions containing rebaudioside M and rebaudioside A at various M/A ratios and concentrations were evaluated using recovery techniques to determine solution stabilities over time.

Ingredients were combined in purified water at room temperature then heated to 85° C. with a heating block to effect dissolution. The solution was allowed to cool to ambient temperature, and then sampled over a period of time to measure the amount of dissolved material.

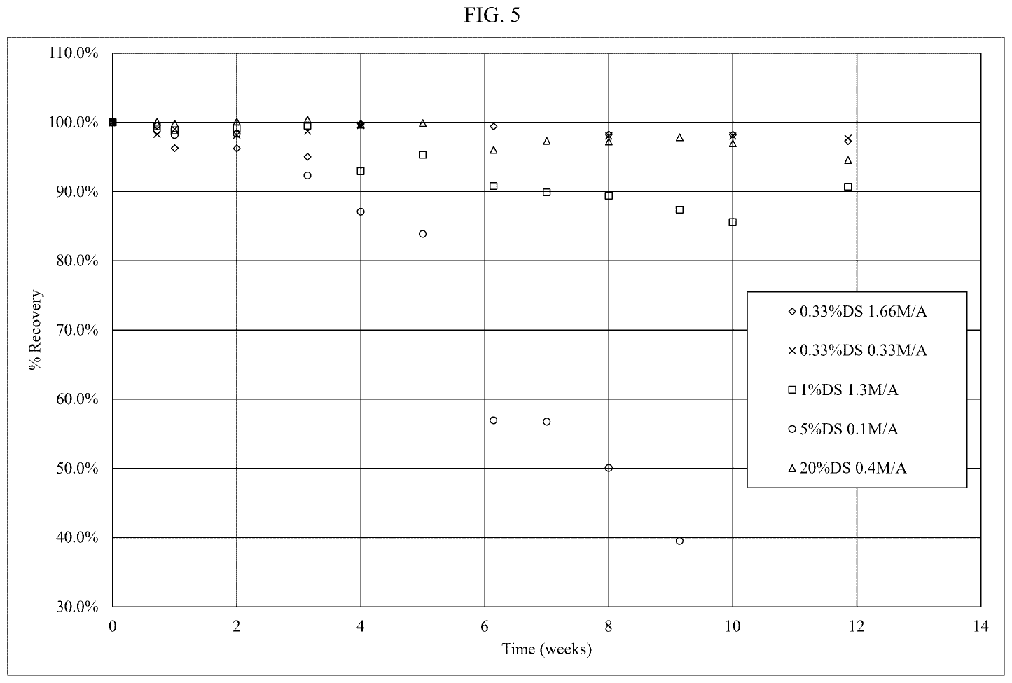

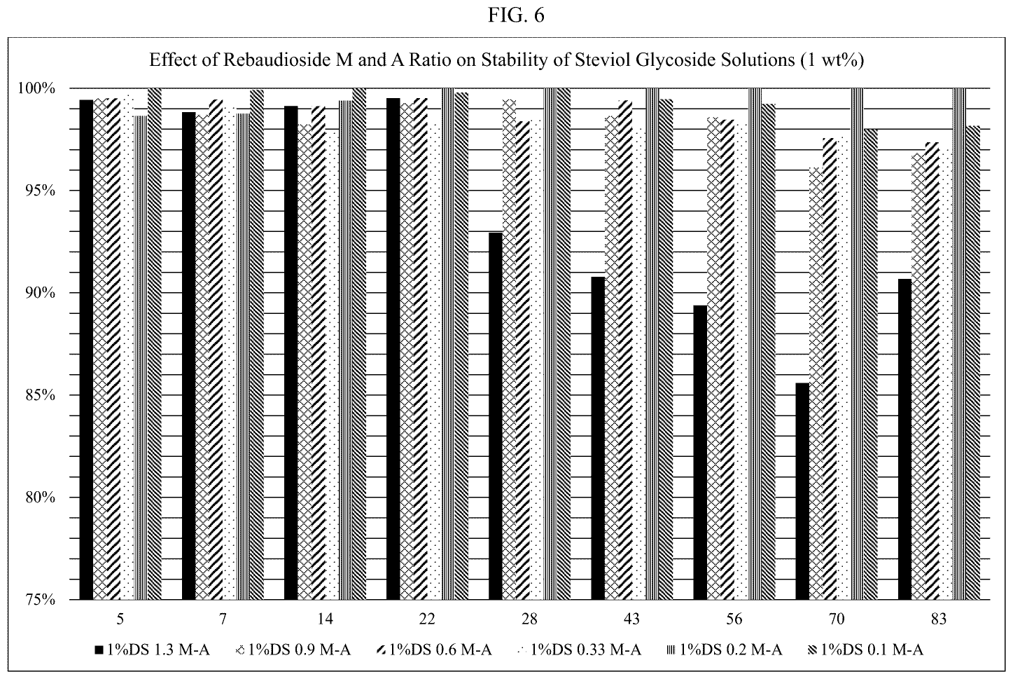

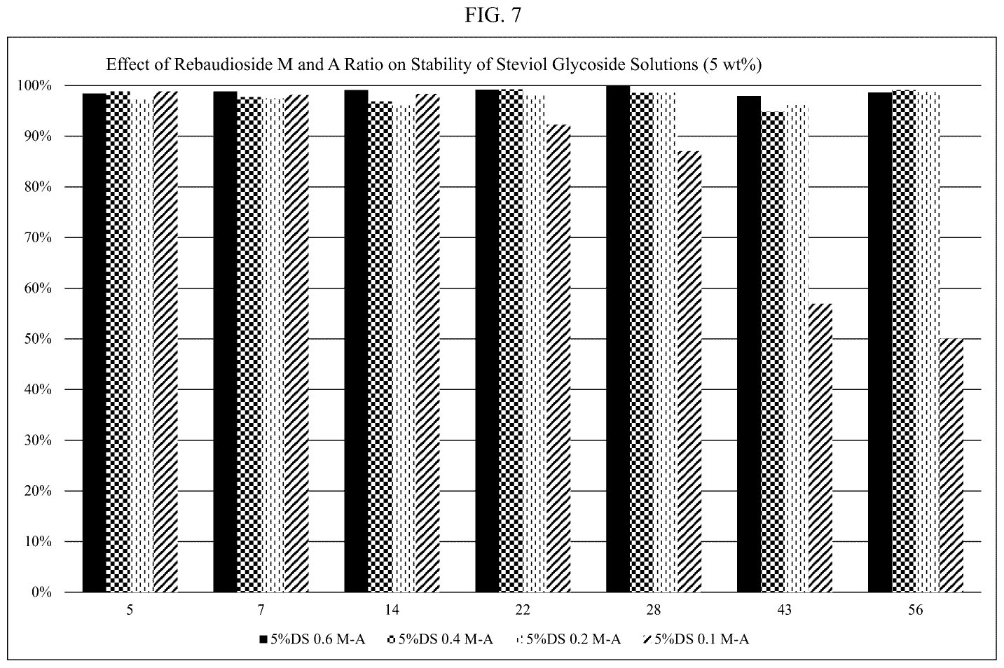

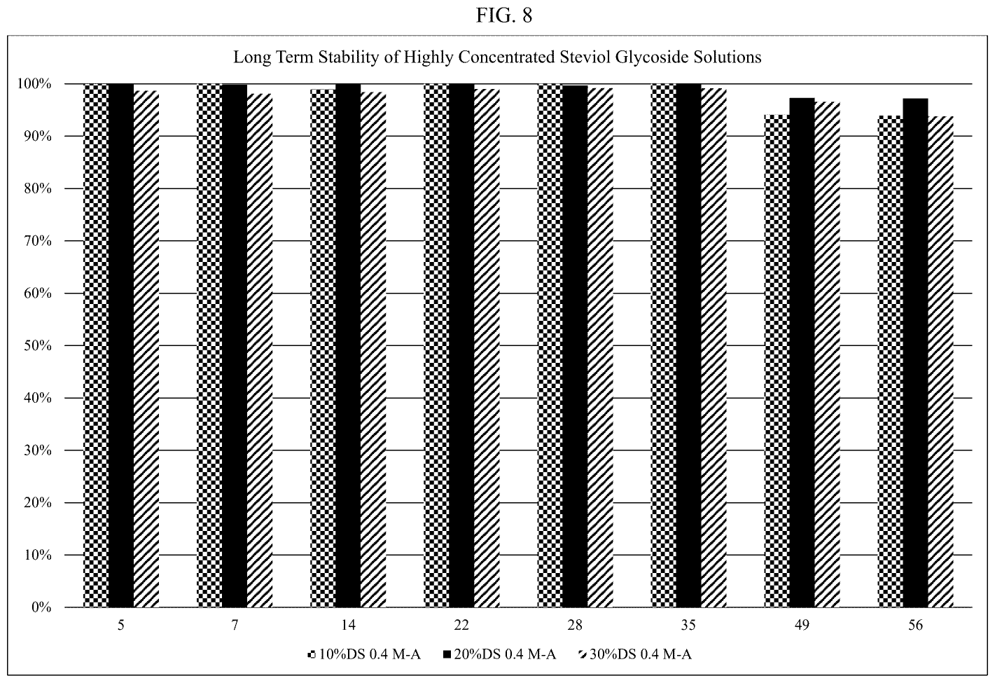

Results are provided in chart form in the figures. FIG. 5 and FIG. 7 show that, over time, a solution having an M/A ratio of 0.1 lost significant amounts of material, credited to precipitation over 9 weeks. This loss of dissolved material greatly accelerating between weeks 5 and 6. FIG. 5 and FIG. 6 show that a sample having 1 wt % total dissolved steviol glycosides and an M/A ratio of 1.3 exhibited meaningfully greater loss of material over about 12 weeks compared to other samples having lower M/A ratios or lower concentrations of dissolved material. FIG. 8 shows that three highly concentrated samples (10 wt %. 20 wt %, and 30 wt %) proved relatively stable over the test period, each having a M/A ratio of 0.4.

### Example 9: Co-drying Steviol Glycoside Pairs to Provide a Cold-Dissolvable Powder

Co-dried steviol glycoside pairs were prepared following the same initial mixing, heating, and cooling steps as previously described in Examples 1-8.

Steviol glycoside mixtures were prepared from RM01 (having about 91 wt % Reb M) and RA95 (having about 96 wt % Reb A), obtained from Cargill, Inc. (Wayzata, MN). The provided M/A ratio is calculated after adjusting for actual rebaudioside M and rebaudioside A content. In the tables of this Example, commercially available rebaudioside M and rebaudioside A mixtures provided the entire amount of dissolved solids. No solubility enhancers or other dissolved solids were used except where expressly noted. No additional solvents were used during the drying step. Formulations were prepared corresponding to M/A ratios of approximately 2:3, 1:1, and 3:2.

Rebaudioside M and rebaudioside A were combined with purified water at room temperature and then heated to 80° C. with a heating block to effect dissolution. The resulting solution was held at 80° C. for several minutes then allowed to cool to room temperature. The resulting room temperature solution was then flash frozen and freeze dried to provide a dried formulation in which the rebaudioside M and rebaudioside A were “co-dried” for the purpose of trying to capture the species responsible for long-term solution stability. The freeze drier operated under high vacuum at −40° C. or lower. The flash freezing was performed in a dry ice and isopropanol bath and completed within approximately 5 minutes. The dried products were dissolved with cold (4° C.) water or room temperature water, and then stored at the same temperature for long-term monitoring. Samples were monitored for more than 92 days.

TABLE 15
Example Co-Dried Material Formulations

| % DS | % DS | % DS | M/A | Co-dried |
|---|---|---|---|---|
| (RM01) | (RA95) | (Total) | Ratio | Formulation # |
| 1.62% | 1.62% | 3.24% | 0.95 | #1 |
| 2.00% | 1.31% | 3.31% | 1.44 | #2 |
| 1.32% | 1.98% | 3.30% | 0.63 | #3 |

TABLE 16
Co-Dried Material Reconstitution

| | Dissolved and stored | | Dissolved and stored | |
|---|---|---|---|---|
| | at 25° C. | | at 4° C. | |
| Co-dried | | Crystallization | % DS | Crystallization |
| Material # | % DS (Total) | Time | (Total) | Time |
| 1 | 0.3% | No visible | 0.3% | No visible |
| | | precipitation | | precipitation |
| 1 | 1.0% | 21 | 1.0% | No visible |
| | | | | precipitation |
| 1 | 5.0% | 17 | 5.0% | 49 |
| 1 | 10.1% | 5 | 10.2% | 35 |
| 1 | 19.9% | 5 | 20.0% | 13 |
| 2 | 0.3% | 31 | 0.3% | No visible |
| | | | | precipitation |
| 2 | 1.0% | 8 | 0.9% | 31 |
| 2 | 5.1% | 3 | 5.1% | 17 |
| 2 | 9.9% | 4 | 10.0% | 11 |
| 2 | 19.8% | <1 | 19.6% | 4 |
| 3 | 0.3% | No visible | 0.3% | No visible |
| | | precipitation | | precipitation |
| 3 | 1.0% | No visible | 1.0% | No visible |
| | | precipitation | | precipitation |
| 3 | 4.9% | No visible | 5.0% | No visible |
| | | precipitation | | precipitation |
| 3 | 9.9% | 92 | 10.2% | No visible |
| | | | | precipitation |
| 3 | 19.9% | 27 | 20.0% | 45 |

Surprisingly, these results suggest that the highly soluble steviol glycosides described in Examples 1-8 can retain their beneficial properties after having their solvent removed. That is, the results show that the dried composition can be readily dissolved and achieve the same beneficial effects of permitting highly concentrated solutions of steviol glycoside, which exhibit long-term stability against precipitation. It is also surprising that the co-dried material permits such solutions to be obtained at room temperature and lower, without a heating step. Because it dissolves easily even at cold temperatures, the co-dried material can be described as cold-dissolvable. Co-drying the aqueous solution of rebaudioside M and rebaudioside A thus provides access to a dry, solid form of the highly soluble steviol glycoside compositions, which may advantageously permit downstream manufacturers to prepare highly concentrated steviol glycoside solutions without requiring burdensome heating and dissolution steps.

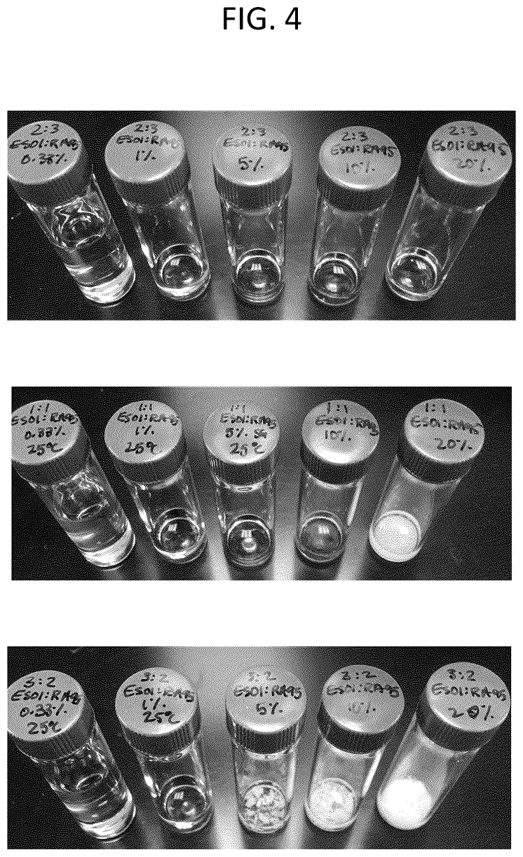

FIG. 4 shows the photographs depicting the results of dissolving, at room temperature, co-dried steviol glycosides having a 2:3, 1:1, or 3:2 M/A ratio. The top row corresponds to co-dried material of Formulation #3 (2:3 concentration ratio of RM01:RA95) dissolved at room temperature at a concentration of, from left to right, 0.33%, 1%, 5%, 10%, and 20%. All concentrations (up to 20% DS tested) in the top row remained clear, dissolved, and free of visible precipitate after two weeks. The middle row shows co-dried material according to of Formulation #1 (1:1 concentration ratio of RM01:RA95) dissolved at room temperature at a concentration of, from left to right, 0.33%, 1%, 5%, 10%, and 20%. Concentrations of 10% and 20% DS showed crystallization within two weeks. The bottom row shows co-dried material of Formulation #2 (3:2 concentration ratio of RM01:RA95) dissolved at room temperature at a concentration of, from left to right, 0.33%, 1%, 5%, 10%, and 20%. The vials having 0.33% and 1% DS remained clear, dissolved, and free of visible precipitate, but other vials showed considerable precipitation and murkiness. These results indicate that increasing ratio of rebaudioside M decreases the long-term solubility of the resulting solutions at high concentrations. Additionally, it appears advantageous with respect to long-term stability for the co-dried material to be formulated with a M: A ratio between 0.2 and 0.9, preferably around 0.4.

### Example 10: Effect of Temperature on Rebaudioside M/A Dissolution Rate

Steviol glycoside samples were prepared and tested to determine the effect of temperature on dissolution rate. Ingredients were combined in purified water at room temperature, then heated to the indicated temperature with a heating block and held at that temperature until completely dissolved. Solutions were observed for dissolution every 30 second. Rebaudioside M and rebaudioside A were used at the weight ratio specified in Table 17. RM90 was used as the source for rebaudioside M and RA95 was used as the source for rebaudioside A. No solubility enhancers or other dissolved solids were used.

TABLE 17

| Total | M/A | Dissolution | Dissolution |
|---|---|---|---|
| SG (% DS) | Ratio | Temperature (° C) | Time (min) |
| 5.64% | 0.87 | 55 | >1380 |
| 5.22% | 0.96 | 60 | 70 |
| 5.04% | 0.90 | 60 | >300 |
| 5.26% | 0.93 | 65 | 4.5 |
| 5.12% | 0.90 | 65 | 16 |
| 5.40% | 1.01 | 70 | 2 |
| 5.00% | 0.95 | 70 | 2.5 |
| 5.34% | 0.93 | 75 | 1.5 |
| 5.04% | 0.93 | 80 | 1 |

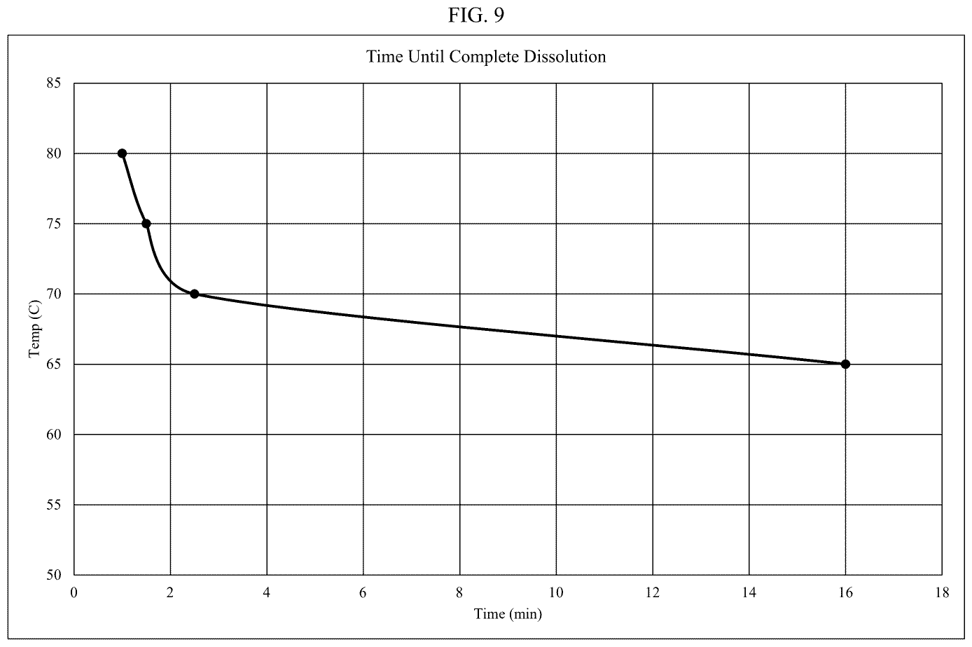

These results show that dissolution rate is significantly increased at temperatures at and above about 65° C. Temperatures below 65° C. resulted in significantly prolonged dissolution times. A subset of the results from Table 17 are shown in FIG. 9.

1. A method for making a stable steviol glycoside concentrate, the method comprising:
a. combining a steviol glycoside composition with an aqueous solvent at a concentration of at least 5% (w/v), the steviol glycoside composition comprising rebaudioside M and rebaudioside A at a relative weight ratio of about 0.15 to about 1.0, and the total concentration of rebaudioside M and rebaudioside A, together, is least 3% (w/v) of the resulting combination;
b. heating the resultant combination at a temperature of 70° C. or greater (e.g., between 70° C. and 90° C.) and completely dissolving the steviol glycoside composition to provide a heated steviol glycoside solution; and
c. cooling the heated steviol glycoside solution to a temperature of 1-35° C. to provide the steviol glycoside concentrate.

2. (canceled)

3. (canceled)

4. A method for making an ingestible sweetened composition, the method comprising:
making a stable steviol glycoside concentrate using the method of claim 1; and
combining the steviol glycoside concentrate with at least one other ingestible ingredient to form the sweetened composition.

5. (canceled)

6. (canceled)

7. The method of claim 4, wherein the total steviol glycosides in the steviol glycoside composition include one or more of rebaudioside D, rebaudioside N, and rebaudioside J.

8. The method of claim 4, wherein the total steviol glycosides in the steviol glycoside composition include one or more of rebaudioside D, rebaudioside N, or rebaudioside J and a concentration of rebaudioside D, rebaudioside N, or rebaudioside J in the steviol glycoside concentrate is higher than a maximum dissolved concentration of rebaudioside D alone, rebaudioside N alone, or rebaudioside J alone in the same solution without the rebaudioside M and rebaudioside A after storage at a temperature of 22° C. for 21 days.

9. The method of claim 4, wherein the steviol glycoside concentrate is held at a temperature of 22° C. for at least 7 days without visible precipitation prior to being combined with an ingestible ingredient a food product.

10. The method of claim 4, wherein the steviol glycoside concentrate is held at a temperature of 22° C. for at least 14 days without visible precipitation prior to being combined with an ingestible ingredient.

11. The method of claim 4, wherein the sweetened composition is a beverage concentrate.

12. (canceled)

13. A method for making a highly soluble steviol glycoside product, the method comprising:
making a stable steviol glycoside concentrate using the method of claim 1; and
drying the steviol glycoside concentrate to provide the highly soluble steviol glycoside product by
i. spray drying the steviol glycoside concentration to provide the highly soluble steviol glycoside product; or
ii. flash freezing the steviol glycoside concentrate to provide a flash freeze product and lyophilizing the flash freeze product to provide the highly soluble steviol glycoside product.

14. (canceled)

15. (canceled)

16. A steviol glycoside concentrate comprising steviol glycosides in an aqueous solution having a total steviol glycoside concentration of at least 5 wt % that produces no visible precipitation in the concentrate if the concentrate is held at a temperature of 22° C. for at least 7 days, wherein the steviol glycoside composition comprises rebaudioside M and rebaudioside A at a ratio of 0.2 to 0.9 and a combined concentration of rebaudioside M and rebaudioside A in the steviol glycoside concentrate is at least 3 wt %.

17. (canceled)

18. The steviol glycoside concentrate of claim 16, wherein the aqueous solution is free of any C1-C4 alcohol or diol.

19. The steviol glycoside concentrate of claim 16, wherein the aqueous solution comprises less than 5 wt % of a C1-C4 alcohol or diol.

20. (canceled)

21. (canceled)

22. The steviol glycoside concentrate of claim 16, wherein the steviol glycosides in the steviol glycoside concentrate include one or more of rebaudioside D, rebaudioside N, and rebaudioside J.

23. The steviol glycoside concentrate of claim 16, wherein the steviol glycosides in the steviol glycoside concentrate include one or more of rebaudioside D, rebaudioside N, or rebaudioside J and a concentration of rebaudioside D, rebaudioside N, or rebaudioside J in the steviol glycoside concentrate is higher than a maximum dissolved concentration of rebaudioside D alone, rebaudioside N alone, or rebaudioside J alone in the same solution without the rebaudioside M and rebaudioside A after storage at a temperature of 22° C. for 21 days.

24. (canceled)

25. (canceled)

26. (canceled)

27. (canceled)

28. The steviol glycoside concentrate of claim 16, comprising rebaudioside A and rebaudioside M in an aqueous solution that produces no visible precipitation in the concentrate if the concentrate is held at a temperature of 22° C. for at least 7 days, wherein
a ratio of the rebaudioside M to the rebaudioside A is 0.2 to 0.9,
a concentration of the rebaudioside M in the aqueous solution is at least 200% (w/v) higher than a maximum dissolved concentration of rebaudioside M alone in the same solution without the other steviol glycosides after storage at a temperature of 22° C. for 21 days, and
a concentration of the rebaudioside A in the aqueous solution is at least 200% (w/v) higher than a maximum dissolved concentration of rebaudioside A alone in the same solution without the other steviol glycosides after storage at a temperature of 22° C. for 21 days.

29. The concentrate of claim 28, wherein the concentration of dissolved rebaudioside M is about 1.5% to about 4.5% (w/v).

30. The concentrate of claim 28, wherein the concentration of dissolved rebaudioside A is about 5.0 wt % to about 9.5 wt % (w/v).

31. (canceled)

32. A method of increasing solubility of rebaudioside D in an aqueous solution, comprising
mixing rebaudioside D, water, rebaudioside M, and rebaudioside A, wherein the weight ratio of rebaudioside M to rebaudioside A is 0.2 to 0.9l, and
the rebaudioside M and rebaudioside A are at a combined concentration of at least 0.25% (w/v) in the mixture, and the weight ratio of rebaudioside M and rebaudioside A relative to total steviol glycoside content is about 0.4 to about 0.8;
heating the resultant combination at a temperature of 70° C. or greater, for at least 1 minute, and completely dissolving the mixture to provide a dissolved steviol glycoside solution; and
cooling the dissolved steviol glycoside solution to a temperature of 1-35° C. to provide the aqueous solution having increased solubility of rebaudioside D.

33. The method of claim 32, wherein the rebaudioside D is at a concentration of about 0.25% (w/v) to about 2.5% (w/v) in the mixture.

34. (canceled)

35. The method of claim 32, wherein a concentration of dissolved rebaudioside D in the aqueous solution is at least 200% higher than a maximum dissolved concentration of rebaudioside D alone in the same solution without the rebaudioside M and rebaudioside A after storage at a temperature of 22° C. for 21 days.

36. The method of claim 32, wherein the aqueous solution is held at a temperature of 22° C. for at least 7 days and produces no visible precipitation.

37. (canceled)
